(19) United States
(12) Patent Application Publication
(10) Pub. No.: US 2013/0063255 A1
(43) Pub. Date: Mar. 14, 2013

(54) COMMUNICATION APPARATUS, COMMUNICATION SYSTEM, COMMUNICATION METHOD

(71) Applicant: Takanori Washiro, Kanagawa (JP)

(72) Inventor: Takanori Washiro, Kanagawa (JP)

(73) Assignee: Sony Corporation, Tokyo (JP)

(21) Appl. No.: 13/592,518

(22) Filed: Aug. 23, 2012

(30) Foreign Application Priority Data
Sep. 8, 2011 (JP) 2011-196302

(51) Int. Cl. G05B 11/01

(52) U.S. Cl. 340/12.32

(57) ABSTRACT

A communication apparatus may include at least one connection terminal configured to connect with at least one external power line coupled to an external apparatus, at least one internal power line configured to carry power and a communication signal to the at least one connection terminal, and a wireless communication circuit connected to the at least one internal power line. The wireless communication circuit may have an input configured to receive the power and the communication signal from the at least one internal power line, and may be configured to separate the communication signal from the power, and to wirelessly transmit the communication signal to the external apparatus. A communication method may include transmitting power and a communication signal via a power line, separating the communication signal from the power via a circuit connected to the power line, and wirelessly transmitting the separated communication signal via a communication antenna.

### FIELD

The present disclosure relates to a communication apparatus, a communication system, and a communication method.

### BACKGROUND

In recent years, devices capable of controlling supply of power to apparatuses connected by power line (for example, capable of selectively interrupting the supply of power to apparatuses which power supply is not necessary), such as, for example, an intelligent tap or a smart tap have appeared with the growing social attention to the environment. Such devices as above use a technique called power line communication (PLC), for example, in which a power line is used as a communication line. For example, JP-A-2003-110471 discloses an example of a technique of performing communication via power line using PLC.

Moreover, various techniques associated with enhancement of the function of power feeding-side apparatuses, such as a power tap or an outlet, for supplying power to power-driven apparatuses have been developed. For example, JP-A-2010-55845 discloses an example of a technique of adding an authentication function to an outlet.

### SUMMARY

However, when performing wired communication by power line using the existing PLC technique, an apparatus that performs communication have to include a communication device which is formed of a relatively large circuit called a PLC modem, for example. Thus, when communication is performed through wires using the existing PLC technique, the cost of the apparatus that performs communication may increase. Moreover, the size of the apparatus that performs communication may be limited. Furthermore, when wired communication by power line is performed using the existing PLC technique, and power is not supplied to the apparatus that performs communication (for example, main power is dormant such as in the off state), it is not possible to perform communication.

Moreover, the outlet according to the technique disclosed in JP-A-2010-55845, for example, performs authentication by performing near field communication (NFC), radio frequency identification (RFID) communication, or biometric authentication to thereby switch between an alert mode and a non-alert mode. Thus, when the outlet according to the technique disclosed in JP-A-2010-55845 is set to the alert mode, the theft of a connected apparatus and the use without permission of the outlet are prevented. Therefore, there is a possibility to enhance security. However, in the technique disclosed in JP-A-2010-55845, for example, since the alert mode and the non-alert mode are switched, the technique is just a technique of adding an existing authentication function using wireless communication or the like to the outlet.

It is therefore desirable to provide a novel and improved communication apparatus, a communication system, and a communication method capable of performing communication with an external apparatus by both wired communication by power line and wireless communication via an antenna connected to a power line.

One type of embodiment is directed to a communication apparatus comprising: at least one connection terminal configured to connect with at least one external power line coupled to an external apparatus; at least one internal power line configured to carry power and a communication signal to the at least one connection terminal; and a wireless communication circuit connected to the at least one internal power line, the wireless communication circuit having an input configured to receive the power and the communication signal from the at least one internal power line, wherein the wireless communication circuit is further configured to separate the communication signal from the power, and to wirelessly transmit the communication signal to the external apparatus.

Another type of embodiment is directed to a communication apparatus comprising: means for connecting with at least one external power line coupled to an external apparatus; means for carrying power and a communication signal to the means for connecting; and means, connected to the means for carrying the power and the communication signal, for wirelessly transmitting the communication signal to the external apparatus.

Another type of embodiment is directed to a system comprising an electronic apparatus configured to receive power and a communication signal via an external power line; and a communication apparatus comprising: at least one connection terminal configured to connect with at least one external power line coupled to the electronic apparatus; at least one internal power line configured to carry power and a communication signal to the at least one connection terminal; and a wireless communication circuit connected to the at least one internal power line, the wireless communication circuit having an input configured to receive the power and the communication signal from the at least one internal power line, wherein the wireless communication circuit is further configured to separate the communication signal from the power, and to wirelessly transmit the communication signal to the electronic apparatus.

Another type of embodiment is directed to a system comprising an electronic apparatus configured to receive power and a communication signal via an external power line; and a communication apparatus comprising: means for connecting with at least one external power line coupled to the electronic apparatus; means for carrying power and a communication signal to the means for connecting; and means, connected to the means for carrying the power and the communication signal, for wirelessly transmitting the communication signal to the electronic apparatus.

Another type of embodiment is directed to a method comprising: transmitting power and a communication signal via a power line; separating the communication signal from the power via a circuit connected to the power line; and wirelessly transmitting the separated communication signal via a communication antenna.

An embodiment of the present disclosure is directed to a communication apparatus including: a connecting unit that connects a power line, through which power having a predetermined frequency and a high-frequency signal having a frequency higher than the frequency of the power are transmitted, to an external apparatus; a first communication filter that is connected to the power line so as to block at least signals having the frequency of the power and not to block the high-frequency signal; and a communication antenna that transmits carrier waves corresponding to the high-frequency signal delivered via the first communication filter.

Another embodiment of the present disclosure is directed to a communication system including: a communication apparatus that performs communication directly with an external apparatus; and a management apparatus that is connected to the communication apparatus by a power line so as to perform communication indirectly with the external apparatus via the communication apparatus, wherein the communication apparatus includes a connecting unit that connects the power line, through which power having a predetermined frequency and a high-frequency signal having a frequency higher than the frequency of the power are transmitted, to the external apparatus, a first communication filter that is connected to the power line so as to block at least signals having the frequency of the power and not to block the high-frequency signal, and a communication antenna that transmits carrier waves corresponding to the high-frequency signal delivered via the first communication filter, and wherein the management apparatus includes a power line communication unit that transmits the high-frequency signal via the power line so as to perform communication with the external apparatus connected through wires via the connecting unit included in the communication apparatus or with the external apparatus capable of performing non-contact communication via the communication antenna included in the communication apparatus, and a second communication filter that is connected between the power line communication unit and the power line so as to block at least signals having the frequency of the power and not to block the high-frequency signal.

Still another embodiment of the present disclosure is directed to a communication method including: transmitting a high-frequency signal via a power line through which power having a predetermined frequency and the high-frequency signal having a frequency higher than the frequency of the power are transmitted, and via a communication antenna that is electrically connected to the power line so as to transmit carrier waves corresponding to the high-frequency signal; and receiving signals transmitted by load modulation from an external apparatus connected through wires by the power line or from an external apparatus capable of performing non-contact communication via the communication antenna.

According to the embodiments of the present disclosure, it is possible to perform communication with an external apparatus by both wired communication by power line and wireless communication via an antenna connected to a power line.

### BRIEF DESCRIPTION OF THE DRAWINGS

FIG. 1 is a diagram illustrating an example of the configuration of a communication apparatus according to a first embodiment.

FIG. 2 is a diagram illustrating an example of the configuration of a first filter and a communication antenna included in the communication apparatus according to the first embodiment.

FIG. 3 is a diagram illustrating another example of the configuration of the first filter and the communication antenna included in the communication apparatus according to the first embodiment.

FIG. 4 is a diagram illustrating an example of the configuration of a power line communication unit included in the communication apparatus according to the first embodiment.

FIG. 5 is a diagram illustrating another example of the configuration of the power line communication unit included in the communication apparatus according to the first embodiment.

FIG. 6 is a diagram illustrating an example of the configuration of a second filter included in the communication apparatus according to the first embodiment.

FIG. 7 is a diagram illustrating an example of the configuration of a third filter included in the communication apparatus according to the first embodiment.

FIG. 8 is a diagram illustrating an example of the configuration of a power line communication unit included in an electronic apparatus according to an embodiment of the present disclosure.

FIG. 9 is a diagram illustrating another example of the power line communication unit included in the electronic apparatus according to the embodiment of the present disclosure.

FIG. 10 is a diagram illustrating an example of the configuration of a communication apparatus according to a second embodiment.

### DETAILED DESCRIPTION

Hereinafter, preferred embodiments of the present disclosure will be described in detail with reference to the accompanying drawings. In this specification and the drawings, the same reference numerals refer to the constituent elements having substantially the same functional configuration, and redundant description thereof will be omitted.

The description will be given in the following order.

1. Communication method according to present embodiment

2. Communication apparatus according to present embodiment

### (Communication Method According to Present Embodiment)

A communication method according to the present embodiment will be described before describing the configuration of a communication apparatus according to the present embodiment. In the following description, it is assumed that the communication apparatus according to the present embodiment performs processes according to the communication method according to the present embodiment.

As described above, when wired communication by power line is performed using the existing PLC technique, for example, the cost of the apparatus that performs communication may increase. Moreover, the size of the apparatus that performs communication may be limited. Furthermore, when wired communication by power line is performed using the existing PLC technique, and power is not supplied to the apparatus that performs communication (for example, main power is dormant such as in the off state), it is not possible to perform communication.

Moreover, when a wireless communication function associated with a NFC communication technique or an RFID communication technique is just added to a communication apparatus to perform wireless communication, it is not possible to perform communication if a counterpart communication apparatus is not capable of performing the wireless communication.

Therefore, the communication apparatus according to the present embodiment is configured to be capable of communication with an external apparatus by both wired communication by power line and wireless communication via a wireless communication circuit connected to a power line. In some embodiments, the wireless communication circuit may include a communication antenna. Hereinafter, wired communication by power line and wireless communication via a wireless communication circuit connected to a power line, which are performed by the communication apparatus according to the present embodiment, will be described.

### [1] Wired Communication by Power Line According to Present Embodiment

Before describing wired communication by power line according to the present embodiment, possible problems in wired communication by power line using the existing PLC technique will be described in more detail.

### [1-1] Possible Problems in Wired Communication by Power Line Using Existing PLC Technique

As described above, when wired communication by power line is performed using the existing PLC technique, even if there is a power-driven apparatus (an example of an external apparatus and will be sometimes referred to an “electronic apparatus”) connected by power line, it is not possible to communicate with the electronic apparatus unless power is supplied to the electronic apparatus.

Moreover, when wired communication by power line is performed using the existing PLC technique, the following problems (a) and (b) may occur, for example.

(a) There is a possibility that a communication failure occurs due to a communication collision.

The existing PLC technique is a bus topology in which apparatuses performing communication via power line use the same band. Thus, when the existing PLC technique is used, there is a possibility that a communication collision occurs if a number of apparatuses are connected to the same band. Moreover, when a communication collision occurs, a communication failure such as inability to perform communication or the occurrence of delay in communication may occur.

(b) There is a possibility that it is difficult to decrease the size of devices associated with communication, and the cost thereof increases.

When wired communication by power line is performed using the existing PLC technique, in order to perform communication, an additional power supply is necessary for both a transmitting-side apparatus that transmits a signal and a receiving-side apparatus that receives a signal to obtain power used for communication. Thus, when wired communication by power line is performed using the existing PLC technique, the electronic apparatus has to include a power supply circuit in order to obtain power for performing communication using the existing PLC technique. Therefore, when wired communication by power line is performed using the existing PLC technique, since the electronic apparatus has to include the power supply circuit, it becomes more difficult to decrease the size of communication devices. Moreover, since the power supply circuit has to be included, the cost increases.

Moreover, it is difficult to decrease the size of communication devices (for example, PLC modems) associated with the existing PLC technique down to the same size as an integrated circuit (IC) chip, for example. Moreover, some communication devices associated with the existing PLC technique are not yet widely used at present and therefore are expensive compared to communication devices having the form of an IC chip, for example.

Thus, when wired communication by power line is performed using the existing PLC technique, it is difficult to decrease the size of devices associated with the communication. Moreover, when wired communication by power line is performed using the existing PLC technique, the electronic apparatus has to include expensive communication devices and an additional power supply circuit. Thus, the cost for performing wired communication by power line may increase.

As above, when wired communication by power line is performed using the existing PLC technique, the further problems (a) and (b) described above may occur.

### [1-2] Overview of Wired Communication by Power Line According to Present Embodiment

Therefore, the communication apparatus according to the present embodiment applies a wireless communication technique such as a NFC communication technique or an RFID technique to the wired communication by power line.

Here, power line according to the present embodiment carries power of a predetermined frequency and a high-frequency communication signal of frequencies higher than the frequency of power. The frequency of power according to the present embodiment may be 0 [Hz] (DC), 50 [Hz], and 60 [Hz], for example. The frequency of the high-frequency communication signal according to the present embodiment may be 13.56 [MHz], for example. The frequency of the high-frequency signal according to the present embodiment is not limited to this. Various frequencies such as, for example, 130 to 135 [kHz], 56 [MHz], 433 [MHz], 954.2 [MHz], 954.8 [MHz], 2441.75 [MHz], or 2448.875 [MHz] can be used as the frequencies of the high-frequency signal according to the present embodiment. Also, in some embodiments, the communication signal may not be a high-frequency signal, as some embodiments are not limited to any particular frequency range for the communication signal. It should be appreciated that when a “high-frequency signal” is referred to hereinafter, a communication signal of a different frequency range may alternatively be used, as aspects of the invention are not limited in this respect.

For example, the high-frequency signal according to the present embodiment may be generated by the communication apparatus according to the present embodiment and transmitted to an external apparatus (this corresponds to a communication apparatus according to a first embodiment described later). The communication apparatus according to the present embodiment may transmit a high-frequency signal generated by another apparatus such as a management apparatus to an external apparatus (this corresponds to a communication apparatus according to a second embodiment described later).

Since the circuit size of communication devices using a wireless communication technique such as a NFC communication technique or an RFID technique is much smaller than the existing PLC modem, the size of the communication devices can be decreased down to the same size as an IC chip, for example. Moreover, since apparatuses, such as a mobile phone in which an IC card or an IC chip is mounted, capable of performing communication using a wireless communication technique such as a NFC communication technique have become popularized, communication devices using a wireless communication technique such as a NFC communication technique or an RFID technique are less expensive than the existing PLC modem.

Furthermore, by applying a wireless communication technique such as a NFC communication technique or an RFID technique to wired communication, an electronic apparatus which is an external apparatus connected through wires by power line to the communication apparatus according to the present embodiment is driven by obtaining power from the high-frequency signal received via power line and performs load modulation to thereby be able to transmit information (data) stored therein and a response signal. That is, when the communication apparatus according to the present embodiment transmits a high-frequency signal to the electronic apparatus via power line, power is supplied to the electronic apparatus, and the electronic apparatus transmits information (data) stored therein and a response signal, for example, with the supplied power. Thus, the electronic apparatus according to the present embodiment can perform wired communication by power line even if the electronic apparatus does not include an additional power supply circuit for performing communication.

Therefore, by applying a wireless communication technique such as a NFC communication technique or an RFID technique to wired communication by power line, it is possible to realize wired communication capable of reducing cost, relieving the limitation of the size of a communication device, and reducing power consumption as compared to wired communication by power line using the existing PLC technique, for example. In addition, wired communication according to the communication method according to the present embodiment is not limited to communication between apparatuses connected by power line but can be applied to apparatuses connected by at least two signal lines, for example.

### [2] Wireless Communication Performed Via Antenna Connected to Power Line According to the Present Embodiment

Next, an overview of wireless communication performed via a wireless communication circuit connected to the power line according to the present embodiment will be described. When the communication apparatus according to the present embodiment performs communication with an external apparatus such as an electronic apparatus by wired communication by power line according to the present embodiment, it is possible to realize wired communication capable of reducing cost, relieving the limitation of the size of a communication device, and reducing power consumption as compared to wired communication by power line using the existing PLC technique.

However, when an external apparatus connected through wires by power line to the communication apparatus according to the present embodiment does not include a communication device (for example, an IC chip) associated with the wired communication by power line according to the present embodiment, for example, the communication apparatus according to the present embodiment and the external apparatus are unable to perform wired communication by power line.

According to a method of enabling communication between the communication apparatus according to the present embodiment and an external apparatus, the communication apparatus according to the present embodiment further includes a communication device according to the existing wireless communication technique such as a NFC communication technique or an RFID technique. When the communication apparatus further includes the communication device associated with the existing wireless communication technique, a communication path through which the communication apparatus according to the present embodiment performs communication with an external apparatus increases. Thus, it is possible to further increase the possibility that the communication apparatus according to the present embodiment can perform communication with an external apparatus.

However, when the communication apparatus according to the present embodiment further includes the communication device according to the existing wireless communication technique such as a NFC communication technique or an RFID technique, the communication apparatus according to the present embodiment independently performs the wired communication by power line according to the present embodiment and the wireless communication associated with the existing wireless communication technique. Thus, when the communication apparatus according to the present embodiment further includes the communication device according to the existing wireless communication technique, the communication apparatus according to the present embodiment have to have a function of generating a high-frequency signal in order to perform at least wireless communication. Furthermore, when the communication apparatus according to the present embodiment has a function of generating a high-frequency signal associated with the wired communication by power line according to the present embodiment, the communication apparatus have to independently include a configuration associated with generation and transmission of a high-frequency signal for wired communication and a configuration associated with generation and transmission of a high-frequency signal for wireless communication. Thus, when the communication apparatus further includes a communication device associated with the existing wireless communication technique, the cost of a device for performing communication with an external apparatus may increase and management of communication may become complex.

Therefore, the communication apparatus according to the present embodiment performs wireless communication via a wireless communication circuit (which may include an antenna) connected to a power line with an external apparatus in addition to the wired communication by power line according to the present embodiment. More specifically, the communication apparatus according to the present embodiment performs non-contact communication with an external apparatus via a communication antenna electrically connected to a power line so as to transmit carrier waves corresponding to a high-frequency signal transmitted via the power line.

In the communication apparatus according to the present embodiment, which performs non-contact communication with an external apparatus via a communication antenna electrically connected to a power line, wired communication by power line according to the present embodiment is integrated with the wireless communication via the communication antenna. That is, the communication apparatus according to the present embodiment can have a configuration in which the communication apparatus does not have a function of generating a high-frequency signal, for example (for example, this corresponds to a communication apparatus according to the second embodiment described later). Moreover, even when the communication apparatus according to the present embodiment has a function of generating a high-frequency signal, for example, the configuration associated with generation and transmission of the high-frequency signal (for example, a power line communication unit described later) can be shared with the wired communication by power line according to the present embodiment and the wireless communication via the communication antenna (for example, this corresponds to a communication apparatus according to the first embodiment described later).

Therefore, the communication apparatus according to the present embodiment can further decrease the cost of devices for performing communication with an external apparatus as compared to a case where the communication apparatus further includes a communication device associated with the existing wireless communication technique. Moreover, the communication apparatus according to the present embodiment can perform management of communication more easily than a case where the communication apparatus further includes a communication device associated with the existing wireless communication technique.

The communication apparatus according to the present embodiment performs communication with an external apparatus, for example, by both wired communication by power line as mentioned in [1] and wireless communication via an antenna connected to a power line as mentioned in [2].

More specifically, the communication apparatus according to the present embodiment transmits a high-frequency signal via power line through which power and a high-frequency signal are transmitted and via a communication antenna electrically connected to a power line (transmitting process). Moreover, the communication apparatus according to the present embodiment receives signals transmitted by load modulation from an external apparatus connected through wires by power line or an external apparatus capable of performing non-contact communication via a communication antenna (receiving process).

The communication apparatus according to the present embodiment can perform communication with an external apparatus by both the wired communication by power line and the wireless communication via an antenna connected to a power line by performing the transmitting process (1) and the receiving process (2) as the process associated with the communication method according to the present embodiment.

### (Communication Apparatus According to Present Embodiment)

Next, an example of a configuration of the communication apparatus according to the present embodiment capable of performing the process associated with the communication method according to the present embodiment will be described.

### [I] Communication Apparatus According to First Embodiment

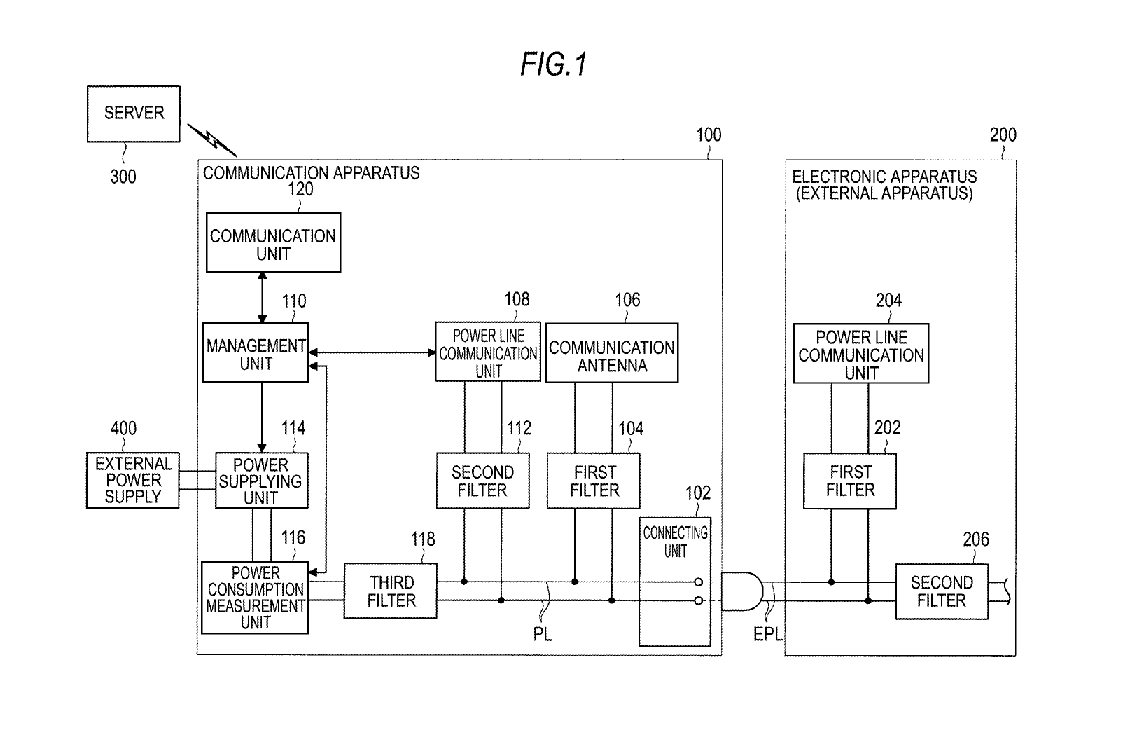

FIG. 1 is a diagram illustrating an example of the configuration of a communication apparatus 100 according to the first embodiment. FIG. 1 also shows an electronic apparatus 200 connected through wires via an external power line EPL to one or more internal power lines PL of communication apparatus 100, a server 300, and an external power supply 400.

Here, the server 300 performs communication with the communication apparatus 100 to receive data such as identification information (described later) transmitted from the communication apparatus 100 and to transmit data used for the communication apparatus 100 to perform processing and a command or the like for causing the electronic apparatus 200 to perform predetermined processing to the communication apparatus 100. Moreover, the server 300 performs power management of the electronic apparatus 200 based on identification information (described later) or information (described later) on power consumption received from the communication apparatus 100 and a process associated with a billing process on the electronic apparatus 200 collaborating with the communication apparatus 100.

Although FIG. 1 shows an example in which the communication apparatus 100 performs communication with the server 300, the configuration of the communication apparatus 100 according to the present embodiment is not limited to this. For example, the communication apparatus 100 may not perform communication with the server 300 and the process realized by communication with the server 300 is performed solely by the communication apparatus 100.

Moreover, the external power supply 400 is an external power supply as viewed from the communication apparatus 100. The external power supply 400 may be a commercial power supply, a battery, or a power generator, for example.

Although FIG. 1 shows an example in which the communication apparatus 100 is connected to the external power supply 400 and is supplied with power from the external power supply 400, the configuration of the communication apparatus 100 according to the present embodiment is not limited to this. For example, when the communication apparatus 100 includes an internal power supply configured to generate the power carried by the internal power line PL, the communication apparatus 100 may not be connected to the external power supply 400.

Hereinafter, an example of the configuration of the communication apparatus 100 will be described. Moreover, an example of the configuration of the electronic apparatus 200 performing wired communication by power line according to the present embodiment and an example of the configuration of an external apparatus (not shown) capable of performing wireless communication via an antenna connected to a power line according to the present embodiment will be described.

### [i] Communication Apparatus 100 According to First Embodiment

The communication apparatus 100 includes a connecting unit 102, a first filter 104 (first communication filter), a communication antenna 106, a power line communication unit 108, a management unit 110, a second filter 112 (second communication filter), a power supplying unit 114, a power consumption measurement unit 116, a third filter 118, and a communication unit 120.

Moreover, the communication apparatus 100 may include a read only memory (ROM: not shown), a random access memory (RAM: not shown), a storage unit (not shown), and a display unit (not shown), for example. The communication apparatus 100 connects respective constituent components by a bus serving as a data transmission path, for example. Here, the ROM (not shown) stores programs used by the management unit 110 or control data such as operation parameters, for example. The RAM (not shown) temporarily stores programs executed by the management unit 110, for example.

The storage unit (not shown) stores identification information (described later) acquired from an external apparatus such as the electronic apparatus 200 and various data such as an application. Here, examples of the storage unit (not shown) include a magnetic recording medium such as a hard disk, a nonvolatile memory such as an electrically erasable and programmable read only memory (EEPROM) or a flash memory. Moreover, the storage unit (not shown) may be removably connected to the communication apparatus 100.

The display unit (not shown) is a display unit included in the communication apparatus 100 and displays various types of information (for example, images and/or characters) on a display screen. Examples of a window displayed on the display screen of the display unit (not shown) include an operation window for allowing a user to perform a desired operation on the communication apparatus 100. Here, examples of the display unit (not shown) include a liquid crystal display (LCD) and an organic EL display (organic electroluminescence display or OLED (organic light emitting diode) display). The display unit (not shown) may be a device capable of displaying data and inputting a user operation, such as a touch screen. Moreover, the communication apparatus 100 may be connected to a display device (for example, an external display) serving as an external apparatus of the communication apparatus 100 regardless of the presence of the display unit (not shown).

Moreover, the communication apparatus 100 may perform communication with an external terminal via a network (or directly) to display the operation window or various types of information on the display screen of the external terminal regardless of whether the communication apparatus 100 includes the display unit (not shown). For example, when the external terminal is an external terminal (for example, a mobile communication apparatus or a remote controller) possessed by the user of the communication apparatus 100, the user can allow the communication apparatus 100 to perform a desired process by operating the external terminal possessed by the user and check information transmitted from the communication apparatus 100 using the external terminal. Thus, in this case, it is possible to improve the convenience of the user even when it is not easy for the user to directly operate the communication apparatus 100 or view the information displayed on the display unit (not shown), for example, when the communication apparatus 100 is installed under a table.

The connecting unit 102 includes one or more connection terminals, for example, and connects the internal power line of communication apparatus 100 to the external power line of an external apparatus. Here, the expression “connect power line to an external apparatus” in the present embodiment means physically and electrically connecting a plug at the distal end of external power line EPL coupled (e.g., connected) to the external apparatus (the electronic apparatus 200) shown in FIG. 1 to the terminal (for example, an outlet) included in the connecting unit 102 or electrically connecting the external power line EPL to the connecting unit 102 via an extension cord.

Moreover, the connecting unit 102 may detect a change in the connection state of the external power line EPL (a change from a non-connection state to a connection state and a change from a connection state to a non-connection state), for example. When the connecting unit 102 detects a change in the connection state of the external power line EPL, the connecting unit 102 delivers a detection signal representing a detection result, for example, to the management unit 110. When the power line communication unit 108 described later has a function of transmitting a high-frequency signal in response to the delivery of the detection signal, the connecting unit 102 may deliver the detection signal to the power line communication unit 108.

Here, when the connecting unit 102 detects a change in the connection state of the external power line EPL, the connecting unit 102 includes a switch that detects a physical connection state of a plug, for example, and delivers a detection signal to the management unit 110 or the like when the state of the switch changes. Naturally, the configuration of the connecting unit 102 associated with detection of a change in the connection state of the external power line EPL is not limited to the above configuration.

The first filter 104 is connected to the power line PL so as to block a signal of a predetermined frequency among the signals transmitted via the power line PL. More specifically, the first filter 104 may be configured to block at least a signal having the frequency of power and to pass (e.g., not to block) a communication signal (e.g., a high-frequency signal).

The communication antenna 106 may be configured to wirelessly transmit carrier waves corresponding to the high-frequency signal delivered via the first communication filter 104. Moreover, the communication antenna 106 receives the high-frequency signal (corresponding to a response signal or the like representing identification information described later, for example) transmitted by load modulation from an external apparatus. That is, the communication antenna 106 performs the function of transmitting and receiving signals to and from an external apparatus in a non-contact manner.

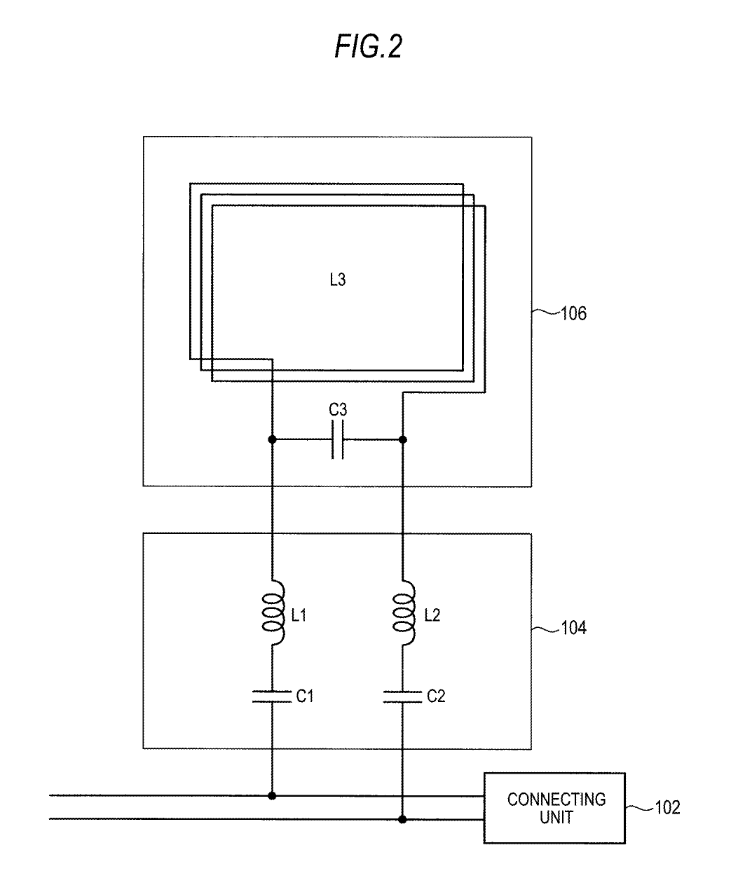

FIG. 2 is a diagram illustrating an example of the configuration of a wireless communication circuit including the first filter 104 and the communication antenna 106 included in the communication apparatus 100 according to the first embodiment. The wireless communication circuit may have an input connected to the internal power line PL, corresponding to the input to the first filter 104. This input may be configured to receive the power and the communication signal, together, from the internal power line.

The first filter 104 includes a band-pass filter made up of a capacitor C1 and an inductor L1 connected in series and a band-pass filter made up of a capacitor C2 and an inductor L2 connected in series. Here, the values of the capacitance of the capacitors C1 and C2 and the values of the inductance of the inductors L1 and L2 are set in accordance with the frequency of the high-frequency signal, for example. More specifically, the values of the capacitance of the capacitors C1 and C2 and the values of the inductance of the inductors L1 and L2 are set so as to satisfy Equation 1 described later, for example. Thus, in some embodiments, the wireless communication circuit may be configured to separate the communication signal from the power, e.g., by blocking the frequency of the power and passing (e.g., not blocking) the frequency of the communication signal.

The configuration of the first filter 104 according to the present embodiment is not limited to the configuration shown in FIG. 2. For example, the first filter 104 may be a filter (for example, a high-pass filter or the like) having an optional configuration capable of blocking a signal having the frequency of power and not blocking a high-frequency signal.

The communication antenna 106 includes a parallel resonance circuit made up of an inductor L3 having a predetermined inductance and a capacitor C3 (capacitance element) having a predetermined capacitance connected in parallel to the inductor L3. Here, FIG. 2 shows an example in which the inductor L3 is a loop antenna.

When the communication antenna 106 is configured as the parallel resonance circuit shown in FIG. 2, the impedance of the communication antenna 106 changes between when an external apparatus such as a mobile phone including an IC card or an IC chip, for example, is within the communication coverage (for example, when the external apparatus is placed over the communication antenna 106) and when the external apparatus is not within the communication coverage. That is, when the communication antenna 106 is configured as the parallel resonance circuit shown in FIG. 2, and the external apparatus is not within the communication coverage, the parallel resonance circuit is in the open state, and the high-frequency signal transmitted by the power line PL is not delivered to the communication antenna 106. On the other hand, when the external apparatus is within the communication coverage, the communication antenna 106 couples with an antenna circuit included in the external apparatus so that a load is applied, whereby the high-frequency signal transmitted by the power line PL is delivered to the communication antenna 106, and the communication antenna 106 transmits carrier waves corresponding to the high-frequency signal.

Here, the resonance frequency of the parallel resonance circuit constituting the communication antenna 106 is set to the frequency of the high-frequency signal, for example. More specifically, the value L of the inductance of the inductor L3 and the value C of the capacitance of the capacitor C3 are set so as to satisfy Equation 1 below, for example. Here, “f” shown in Equation 1 represents the frequency of a high-frequency signal, such as 13.56 [MHz], for example.

$$2 π f = \frac{1}{\sqrt{LC}}$$

Since the communication apparatus 100 includes the first filter 104 and the communication antenna 106 having the configuration shown in FIG. 2, the communication apparatus 100 can perform wireless communication via the power line PL according to the present embodiment with the external apparatus. The configurations of the first filter 104 and the communication antenna 106 included in the communication apparatus 100 according to the first embodiment is not limited to the configuration shown in FIG. 2.

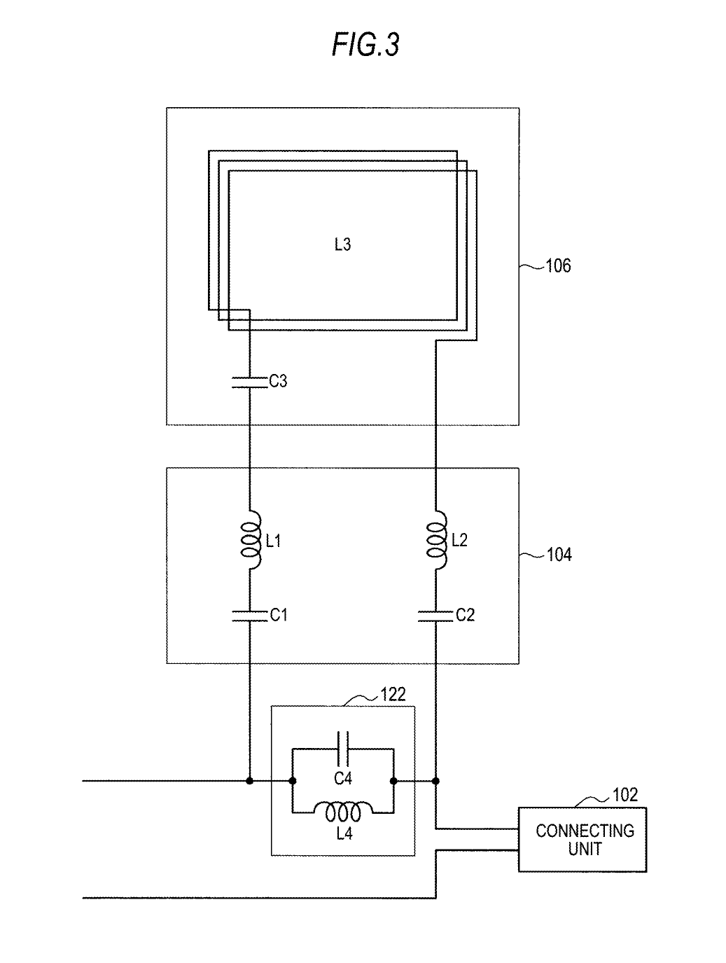

FIG. 3 is a diagram illustrating another example of the configuration of a wireless communication circuit including a first filter 104 and a communication antenna 106 included in the communication apparatus 100 according to the first embodiment.

The first filter 104 includes a band-pass filter made up of a capacitor C1 and an inductor L1 and a band-pass filter made up of a capacitor C2 and an inductor L2, for example, similarly to the first filter 104 shown in FIG. 2. Here, the values of the capacitance of the capacitors C1 and C2 and the values of the inductance of the inductors L1 and L2 are set in accordance with the frequency of the high-frequency signal, for example.

The communication antenna 106 includes a series resonance circuit made up of an inductor L3 having a predetermined inductance and a capacitor C3 (capacitance element) having a predetermined capacitance connected in series to the inductor L3. Here, FIG. 3 shows an example in which the inductor L3 is a loop antenna similarly to the inductor L3 shown in FIG. 2.

When the communication antenna 106 is configured as the series resonance circuit shown in FIG. 3, the impedance of the communication antenna 106 changes between when an external apparatus such as a mobile phone including an IC card or an IC chip, for example, is within the communication coverage and when the external apparatus is not within the communication coverage. That is, when the communication antenna 106 is configured as the series resonance circuit shown in FIG. 3, and the external apparatus is not within the communication coverage, the series resonance circuit is in the short state, and the high-frequency signal transmitted by the power line PL is delivered to the connecting unit 102 via the communication antenna 106. On the other hand, when the external apparatus is within the communication coverage, the communication antenna 106 couples with an antenna circuit included in the external apparatus so that a load is applied, whereby the high-frequency signal transmitted by the power line PL is delivered to the communication antenna 106.

Therefore, since the communication apparatus 100 includes the first filter 104 and the communication antenna 106 having the configuration shown in FIG. 3, the communication apparatus 100 can perform wireless communication via the power line PL according to the present embodiment with the external apparatus. Here, the resonance frequency of the series resonance circuit constituting the communication antenna 106 is set to the frequency of the high-frequency signal, for example. More specifically, the value L of the inductance of the inductor L3 and the value C of the capacitance of the capacitor C3 are set so as to satisfy Equation 1 above, for example.

When the communication antenna 106 is configured as the series resonance circuit shown in FIG. 3, even if the power delivered by the power line PL is a high-voltage signal, the power can be blocked by the capacitor C3 constituting the series resonance circuit. Thus, when the communication antenna 106 is configured as the series resonance circuit shown in FIG. 3, the communication apparatus 100 may have a configuration in which the communication apparatus 100 does not include the first filter 104, as the capacitor C3 may be configured to block the frequency of the power.

Moreover, when the communication antenna 106 is configured as the series resonance circuit shown in FIG. 3, the communication apparatus 100 further includes a filter 122 disposed between two contacts, at which the first filter 104 is connected to the power line PL, so as to block a high-frequency signal and not to block a signal having the frequency of power. Here, FIG. 3 shows an example in which the filter 122 is a band-stop filter made up of a capacitor C4 and an inductor L4 connected in parallel. The value of the capacitance of the capacitor C4 and the value of the inductance of the inductor L4 are set in accordance with the frequency of a high-frequency signal, for example.

The configuration of the filter 122 according to the present embodiment is not limited to the configuration shown in FIG. 3. For example, the filter 122 may be a filter (for example, a low-pass filter or the like) having an optional configuration capable of blocking a high-frequency signal and not blocking a signal having the frequency of power.

An example of the configuration of the communication apparatus 100 according to the first embodiment will be described with reference again to FIG. 1. The power line communication unit 108 has the function of performing communication with an external apparatus such as the electronic apparatus 200 via the power line PL.

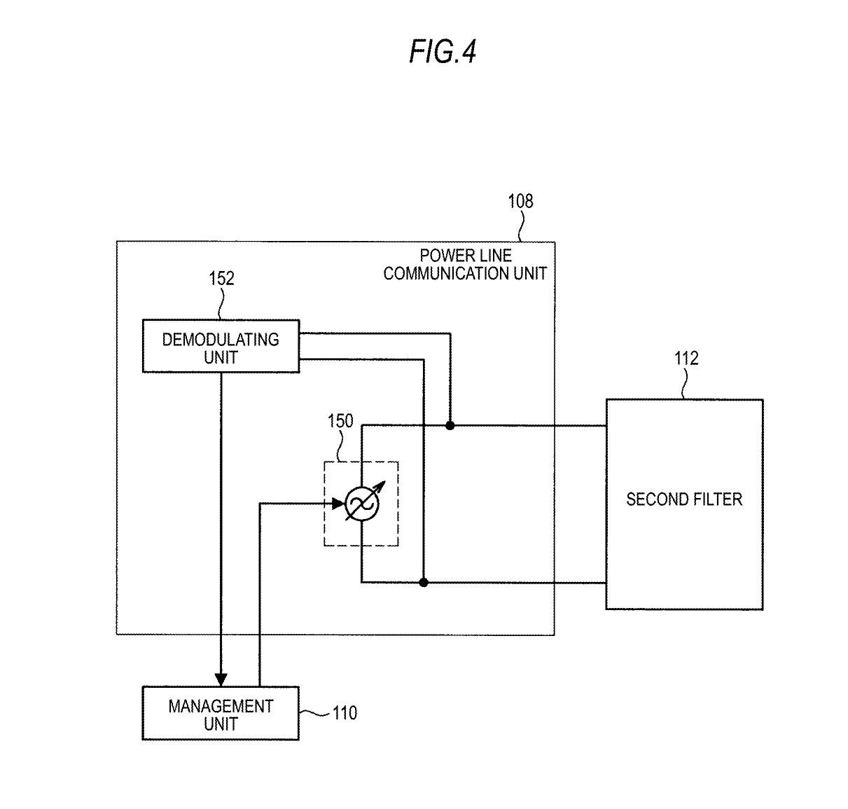

FIG. 4 is a diagram illustrating an example of the configuration of the power line communication unit 108 included in the communication apparatus 100 according to the first embodiment. FIG. 4 also shows the management unit 110 and the second filter 112. For example, the power line communication unit 108 includes a high-frequency signal generating unit 150 and a demodulating unit 152 and performs the role of a reader/writer (or an interrogator) used in the NFC communication technique or the like. Moreover, the power line communication unit 108 may further include an encryption circuit (not shown), a communication collision-prevention (anti-collision) circuit, and the like, for example.

The high-frequency signal generating unit 150 receives a high-frequency signal generation command delivered from the management unit 110, for example, and generates a high-frequency signal corresponding to the high-frequency signal generation command. Moreover, the high-frequency signal generating unit 150 receives a high-frequency signal transmission stop command representing stoppage of transmission of high-frequency signal, delivered from the management unit 110, for example, and stops generating the high-frequency signal. Here, although FIG. 4 shows an AC power supply as the high-frequency signal generating unit 150, the high-frequency signal generating unit 150 according to the present embodiment is not limited to this. For example, the high-frequency signal generating unit 150 according to the present embodiment may include a modulating circuit (not shown) that performs amplitude shift keying (ASK) modulation and an amplifying circuit (not shown) that amplifies the output of the modulating circuit.

Here, examples of the high-frequency signal generated by the high-frequency signal generating unit 150 include a first high-frequency signal and a second high-frequency signal. The first high-frequency signal according to the present embodiment is a high-frequency signal including a transmission command for transmitting identification information to an external apparatus, for example. Moreover, the second high-frequency signal according to the present embodiment is a high-frequency signal including a process execution command for causing an external apparatus (that is, an external apparatus connected through wires by the power line PL or an external apparatus performing wireless communication via an antenna connected to the power line PL) which is a communication counterpart of the wired communication and the wireless communication according to the present embodiment to perform a predetermined process, and processing data or the like, for example.

Moreover, the identification information according to the present embodiment is information (data) which can be used for identifying an external apparatus which is a communication counterpart of the wired communication and the wireless communication according to the present embodiment. Examples of the identification information include data representing an identification number unique to an apparatus and data (for example, data representing a maker, a model number, or the like) representing the type of an apparatus. The identification information according to the present embodiment is not limited to the above example as long as the information can be used of identifying an external apparatus which is a communication counterpart of the wired communication and the wireless communication according to the present embodiment.

The high-frequency signal according to the present embodiment is not limited to the above. For example, the high-frequency signal according to the present embodiment may be a signal (for example, an unmodulated signal) that performs the function of supplying power to the external apparatus (more specifically, a device included in the external apparatus in order to perform the wired communication and the wireless communication according to the present embodiment, such as the power line communication unit 204 included in the electronic apparatus 200 described later). The signal that performs the function of supplying power may perform the function of the first high-frequency signal (that is, a case where the first high-frequency signal is an unmodulated signal).

The demodulating unit 152 detects a change in the amplitude of the voltages between the high-frequency signal generating unit 150 and the second filter 112 by envelope detection and digitizes the detected signal to thereby demodulate the response signal (more specifically, the response signal transmitted by load modulation, for example) transmitted from the external apparatus such as the electronic apparatus 200. Moreover, the demodulating unit 152 delivers the demodulated response signal (for example, a response signal representing identification information or a response signal representing a response based on a process corresponding to the second high-frequency signal) to the management unit 110. A method of demodulating the response signal in the demodulating unit 152 is not limited to the above, and for example, the response signal may be demodulated using a change in the phase of the voltages between the high-frequency signal generating unit 150 and the second filter 112.

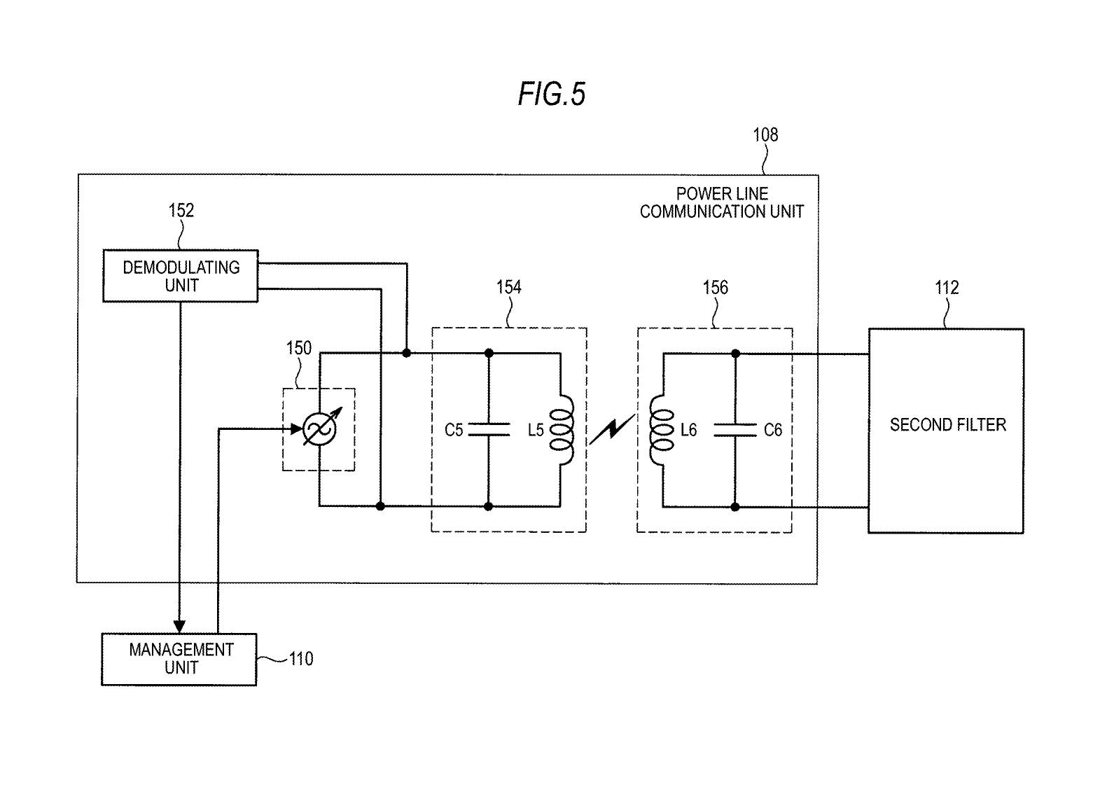

The configuration of the power line communication unit 108 according to the first embodiment is not limited to the configuration shown in FIG. 4. FIG. 5 is a diagram illustrating another example of the configuration of the power line communication unit 108 included in the communication apparatus 100 according to the first embodiment. FIG. 5 also shows the management unit 110 and the second filter 112 similarly to FIG. 4.

The power line communication unit 108 shown in FIG. 5 includes a high-frequency signal generating unit 150, a demodulating unit 152, a first high-frequency transceiving unit 154, and a second high-frequency transceiving unit 156. Moreover, the power line communication unit 108 may further include an encryption circuit (not shown), a communication collision-prevention (anti-collision) circuit, and the like, for example.

Similarly to the high-frequency signal generating unit 150 shown in FIG. 4, the high-frequency signal generating unit 150 generates a high-frequency signal in response to a high-frequency signal generation command and stops generating the high-frequency signal in response to a high-frequency signal transmission stop command.

The demodulating unit 152 detects a change in the amplitude of the voltages at the antenna terminals of the high-frequency signal generating unit 150 by envelope detection and digitizes the detected signal to thereby demodulate the response signal transmitted from the electronic apparatus 200. A method of demodulating the response signal in the demodulating unit 152 is not limited to the above. For example, the demodulating unit 152 may demodulate the response signal using a change in the phase of the voltages at the antenna terminals of the high-frequency signal generating unit 150.

The first high-frequency transceiving unit 154 includes an inductor L5 having a predetermined inductance and a capacitor C5 having a predetermined capacitance, for example, and constitutes a resonance circuit. Here, the resonance frequency of the first high-frequency transceiving unit 154 may be the frequency of the high-frequency signal, such as 13.56 [MHz], for example. With the above configuration, the first high-frequency transceiving unit 154 transmits the high-frequency signal generated by the high-frequency signal generating unit 150 and receives the response signal transmitted from an external apparatus such as the electronic apparatus 200, transmitted from the second high-frequency transceiving unit 156. That is, the first high-frequency transceiving unit 154 performs the function of a first communication antenna in the power line communication unit 108.

The second high-frequency transceiving unit 156 includes an inductor L6 having a predetermined inductance and a capacitor C6 having a predetermined capacitance, for example, and constitutes a resonance circuit. Here, the resonance frequency of the second high-frequency transceiving unit 156 may be the frequency of the high-frequency signal, such as 13.56 [MHz], for example. With the above configuration, the second high-frequency transceiving unit 156 receives the high-frequency signal transmitted from the first high-frequency transceiving unit 154 and transmits the response signal transmitted from an external apparatus such as the electronic apparatus 200. That is, the second high-frequency transceiving unit 156 performs the function of a second communication antenna in the power line communication unit 108.

The power line communication unit 108 according to the first embodiment having the configuration shown in FIG. 5 can perform the function of a reader/writer in the NFC communication technique or the like and perform the function of performing communication with the external apparatus such as the electronic apparatus 200 via the power line PL in the same manner as the configuration shown in FIG. 4.

The configuration of the communication apparatus 100 according to the first embodiment will be described with reference again to FIG. 1. The management unit 110 is configured as a micro processing unit (MPU), one or more processors, an integrated circuit in which various processing circuits are integrated, and the like and performs the function of a control unit that controls respective units of the communication apparatus 100. More specifically, the management unit 110 delivers the high-frequency signal generation command and the high-frequency signal transmission stop command to the power line communication unit 108, for example, based on the detection signal delivered from the connecting unit 102 and the response signal from the external apparatus such as the electronic apparatus 200, delivered from the power line communication unit 108 to thereby control communication in the power line communication unit 108.

When the management unit 110 delivers the high-frequency signal generation command and the high-frequency signal transmission stop command to the power line communication unit 108 based on the detection signal, for example, the communication apparatus 100 can perform communication with the external apparatus such as the electronic apparatus 200 that is actually connected through wires via the power line PL. Moreover, when the management unit 110 delivers the high-frequency signal generation command and the high-frequency signal transmission stop command to the power line communication unit 108 as described above, the power line communication unit 108 can transmit the first high-frequency signal based on the detection result in the connecting unit 102, for example.

Moreover, when the management unit 110 delivers the high-frequency signal generation command and the high-frequency signal transmission stop command to the power line communication unit 108 based on the response signal, the management unit 110 can control the wired communication by the power line PL with the external apparatus and the wireless communication via the power line PL with the external apparatus. The management unit 110 may deliver the high-frequency signal generation command to the power line communication unit 108 on a periodic or non-periodic basis and transmit the first high-frequency signal to the power line communication unit 108 on a periodic or non-periodic basis.

Moreover, the management unit 110 controls the operation of the power supplying unit 114 by delivering a control signal to the power supplying unit 114 so as to control the selective supply of power to the power line PL in the power supplying unit 114, for example. For example, in some embodiments, one or more processors of management unit 110 may be programmed to cause the internal power line PL to be selectively connected to external power supply 400 or to an internal power supply.

Moreover, the management unit 110 controls the operation of the power consumption measurement unit 116 by delivering a control signal to the power consumption measurement unit 116 so as to control the start and stop of the measurement of power consumed by the external apparatus such as the electronic apparatus 200 connected through wires by the power line PL in the power consumption measurement unit 116, for example.

Moreover, the management unit 110 may control the communication in the communication unit 120.

The communication apparatus 100 according to the present embodiment may additionally include a control unit (not shown) that controls respective units of the communication apparatus 100, such as the power supplying unit 114, the power consumption measurement unit 116, or the communication unit 120, for example.

Moreover, the management unit 110 specifies an external apparatus connected through wires by the power line PL or an external apparatus performing wireless communication via an antenna connected to the power line PL based on the identification information which is received by the power line communication unit 108 from the external apparatus such as the electronic apparatus 200 via the power line PL. Here, since the management unit 110 can specify a communication counterpart external apparatus based on the received identification information as described above, the management unit 110 may authenticate the communication counterpart external apparatus using the identification information. Although the management unit 110 authenticates the communication counterpart external apparatus based on a database in which identification information and the type of an executable process are stored in correlation and the received identification information, an authentication method used in the management unit 110 is not limited to the above. For example, the management unit 110 can authenticate the communication counterpart external apparatus using an optional method as long as it can authenticate the communication counterpart external apparatus.

The second filter 112 is connected between the power line communication unit 108 and the power line PL and performs the function of filtering signals delivered from the power line PL. More specifically, the second filter 112 has a function of blocking at least power transmitted by the power line PL and not blocking a high-frequency signal among the signals delivered from the power line PL. Since the communication apparatus 100 includes the second filter 112, power which can become noise is not delivered to the power line communication unit 108. Thus, it is possible to improve accuracy of communication between the power line communication unit 108 and the external apparatus which is the communication counterpart of the wired communication and the wireless communication according to the present embodiment.

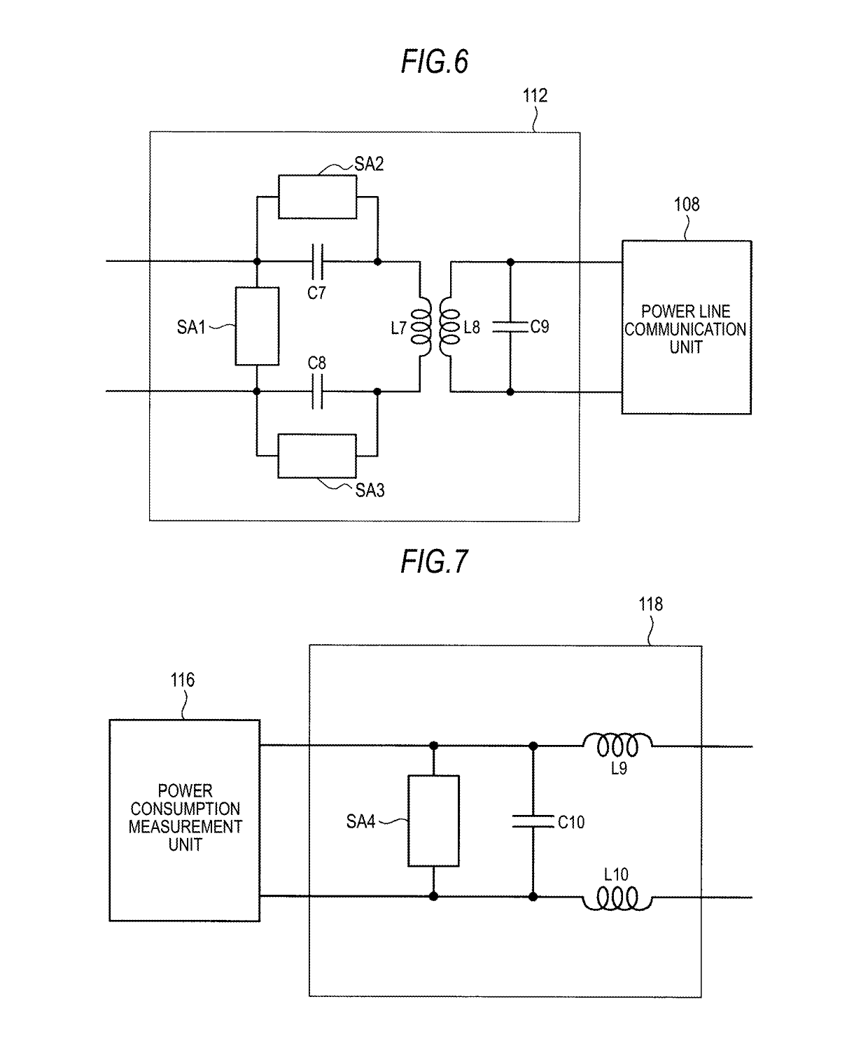

FIG. 6 is a diagram illustrating an example of the configuration of the second filter 112 included in the communication apparatus 100 according to the first embodiment. The second filter 112 is made up of inductors L7 and L8, capacitors C7 to C9, and surge absorbers SA1 to SA3. Naturally, the configuration of the second filter 112 according to the present embodiment is not limited to the configuration shown in FIG. 6.

The configuration of the communication apparatus 100 according to the first embodiment will be described with reference again to FIG. 1. The power supplying unit 114 selectively connects the power line PL to an internal power supply (not shown) or the external power supply 400 based on a control signal generated by and delivered from the management unit 110 (or a control unit when an additional control unit (not shown) is included) to thereby selectively supply power to the power line PL. Here, a switch which is turned on/off based on a control signal may be used as the power supplying unit 114, for example. Here, although the switch is configured as a p-channel metal-oxide-semiconductor field-effect transistor (MOSFET) or an n-channel MOSFET, the configuration of the switch is not limited to this. The communication apparatus 100 according to the first embodiment may not include the power supplying unit 114.

The power consumption measurement unit 116 measures power consumed by the external apparatus such as the electronic apparatus 200, connected to the power line PL via the connecting unit 102. Moreover, the power consumption measurement unit 116 delivers information on the measured power consumption to the management unit 110. Moreover, the power consumption measurement unit 116 may selectively measure the power consumption based on a control signal delivered from the management unit 110 (or a control unit when an additional control unit (not shown) is included). Here, the power consumption measurement unit 116 may be a power consumption meter, for example. In the communication apparatus 100 according to the first embodiment, the power consumption measurement unit 116 may be not included.

The third filter 118 is provided on the power line PL between the connecting unit 102 and the power consumption measurement unit 116 and performs the function of filtering signals which can be delivered from the side of the connecting unit 102. More specifically, the third filter 118 has a function of blocking at least the high-frequency signal transmitted by the power line communication unit 108 and the high-frequency signal transmitted by the external apparatus which is the communication counterpart of the wired communication and the wireless communication according to the present embodiment and not blocking power supplied to the external apparatus such as the electronic apparatus 200 connected to the power line PL via the connecting unit 102. Since the communication apparatus 100 includes the third filter 118, it is possible to block the high-frequency signal associated with communication via the power line and noise components which can be delivered from the side of the external apparatus such as the electronic apparatus 200 connected to the power line PL via the connecting unit 102. That is, the third filter 118 performs the function of a so-called power splitter.

FIG. 7 is a diagram illustrating an example of the configuration of the third filter 118 included in the communication apparatus 100 according to the first embodiment. The third filter 118 is made up of inductors L9 and L10, a capacitor C10, and a surge absorber SA4. Naturally, the configuration of the third filter 118 according to the present embodiment is not limited to the configuration shown in FIG. 7.

The communication unit 120 is a communication unit included in the communication apparatus 100 and performs communication through wires or wirelessly with the server 300. Moreover, the communication of the communication unit 120 is controlled by the management unit 110 (or a control unit when an additional control unit (not shown) is included). Here, the communication unit 120 may be a combination of a local area network (LAN) terminal and a transceiving circuit, a combination of an IEEE 802.11g port and a transceiving circuit, a combination of an IEEE 802.15.4 port and a transceiving circuit, or a combination of a communication antenna and a radio frequency (RF) circuit, for example. The configuration of the communication unit 120 according to the first embodiment is not limited to the above. For example, the communication unit 120 may have an optional configuration capable of communicating with the external apparatus such as the server 300 via a network (or directly). In the communication apparatus 100 according to the first embodiment, the communication unit 120 may be not included.

The communication apparatus 100 according to the first embodiment transmits a high-frequency signal via the power line PL through which power and a high-frequency signal are transmitted and via the communication antenna 106 electrically connected to the power line PL. Moreover, the communication apparatus 100 receives signals transmitted by load modulation from an external apparatus connected through wires by the power line PL or from an external apparatus capable of perform communication in a non-contact manner via the communication antenna 106. That is, with the configuration shown in FIG. 1, for example, the communication apparatus 100 can perform processing (for example, the processing (transmitting process) (1) and the processing (receiving process) (2)) associated with the communication method according to the present embodiment.

Therefore, with the configuration shown in FIG. 1, for example, the communication apparatus 100 can perform communication with the external apparatus by both the wired communication by the power line PL and the wireless communication via the antenna connected to the power line PL.

[ii] Electronic Apparatus 200

Next, the electronic apparatus 200 according to the present embodiment shown in FIG. 1 will be described. The electronic apparatus 200 performs processes and operations corresponding to the function possessed by the electronic apparatus 200 by the power supplied via the power line.

Moreover, the electronic apparatus 200 is driven by obtaining power from the high-frequency signal received via the power line PL, for example, and performs wired communication via the power line with the communication apparatus 100 regardless of whether or not power is supplied via the power line PL.

More specifically, when the first high-frequency signal is received, for example, the electronic apparatus 200 reads identification information stored therein using the power obtained from the first high-frequency signal. Moreover, the electronic apparatus 200 transmits the identification information as a high-frequency signal by superimposing the identification information on the power line PL by load modulation using the power.

Moreover, when the second high-frequency signal is received, the electronic apparatus 200 performs a predetermined process requested by the second high-frequency signal using power obtained from the second high-frequency signal. Moreover, the electronic apparatus 200 transmits a response signal corresponding to the predetermined process as a high-frequency signal by superimposing the response signal on the power line PL by load modulation using the power. Here, the predetermined process requested by the second high-frequency signal performed by the electronic apparatus 200 may be a process associated with a billing process such as transmission of the value of an electronic value stored or updating of the value of the electronic value. The predetermined process requested by the second high-frequency signal performed by the electronic apparatus 200 according to the present embodiment is not limited to the billing process. For example, the electronic apparatus 200 may perform a process of controlling a power supply such as turning on/off the main power supply of the electronic apparatus 200 or transitioning to a power-saving mode, an authentication process, or the like based on the received second high-frequency signal.

Referring to FIG. 1, the electronic apparatus 200 includes the first filter 202, the power line communication unit 204, and the second filter 206.

Moreover, the electronic apparatus 200 includes a battery (not shown) and various devices (not shown) for realizing the function possessed by the electronic apparatus 200, for example, at the subsequent stage (a side of the second filter 206 opposite to the communication apparatus 100 shown in FIG. 1) of the second filter 206. That is, the electronic apparatus 200 can charge the battery (not shown) with power corresponding to the power supplied via the power line PL from the communication apparatus 100, for example, and realizes the function possessed by the electronic apparatus 200 using the supplied power. For example, when the electronic apparatus 200 is a vehicle such as an electric vehicle (EV), the electronic apparatus 200 charges a built-in battery by being supplied with power and drives a motor using the power of the battery, for example. Moreover, when the electronic apparatus 200 has a display device capable of displaying images (moving or still images) and/or characters, the electronic apparatus 200 displays images and characters on the display screen of the display device by being supplied with power.

The first filter 202 is connected between the power line (strictly speaking, the external power line EPL in the electronic apparatus 200, the same herein below) and the power line communication unit 204 and performs the function of filtering signals delivered from the power line. More specifically, the first filter 202 has a function of blocking at least power and not blocking a high-frequency signal among the signals delivered from the power line. Since the electronic apparatus 200 includes the first filter 202, power which can become noise is not delivered to the power line communication unit 204. Thus, it is possible to improve the accuracy of communication between the power line communication unit 108 of the communication apparatus 100 and the power line communication unit 204.

Here, the first filter 202 can have the same configuration as the second filter 112 included in the communication apparatus 100 shown in FIG. 6, for example. Naturally, the configuration of the first filter 202 included in the electronic apparatus 200 according to the present embodiment is not limited to the configuration shown in FIG. 6.

The power line communication unit 204 performs communication with the communication apparatus 100 via the power line by a high-frequency signal. More specifically, when the high-frequency signal transmitted from the communication apparatus 100 is received, the power line communication unit 204 is driven by obtaining power from the high-frequency signal and performs a process indicated by the received high-frequency signal. Moreover, the power line communication unit 204 transmits a response signal corresponding to the process by load modulation as a high-frequency signal. For example, when the first high-frequency signal is received, the power line communication unit 204 transmits identification information stored therein so as to be superimposed on the power line by load modulation in accordance with the first high-frequency signal. Moreover, when the second high-frequency signal is received, for example, the power line communication unit 204 performs a process based on the second high-frequency signal and transmits a response signal based on the process so as to be superimposed on the power line. That is, the power line communication unit 204 performs the role of a transponder used in the NFC communication technique or the like.

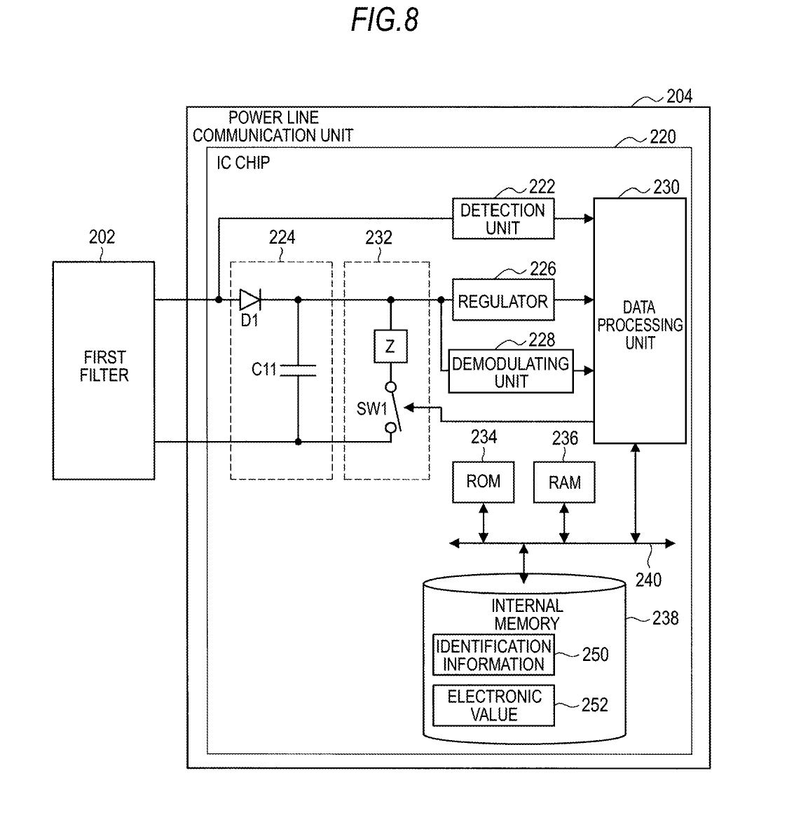

FIG. 8 is a diagram illustrating an example of the configuration of the power line communication unit 204 included in the electronic apparatus 200 according to the present embodiment. FIG. 8 also shows the first filter 202. The power line communication unit 204 includes an IC chip 220 that demodulates the received high-frequency signal and transmits a response signal by load modulation. In the power line communication unit 204 according to the present embodiment, the respective constituent components constituting the IC chip 220 shown in FIG. 8 may not necessarily have the form of an IC chip.

The IC chip 220 includes a detection unit 222, a wave detector 224, a regulator 226, a demodulating unit 228, a data processing unit 230, and a load modulation unit 232. Although not shown in FIG. 8, the IC chip 220 may further include a protection circuit (not shown) for preventing an overvoltage or overcurrent from being applied to the data processing unit 230, for example. Here, the protection circuit (not shown) may be a clamp circuit formed of diodes, for example.

Moreover, the IC chip 220 includes a ROM 234, a RAM 236, an internal memory 238, and the like. The data processing unit 230, the ROM 234, the RAM 236, and the internal memory 238 are connected by a bus 240 serving as a data transmission path, for example.

The ROM 234 stores programs used by the data processing unit 230 and control data such as operation parameters. The RAM 236 temporarily stores programs executed by the data processing unit 230, operation results, execution states, and the like.

The internal memory 238 is a storage unit included in the IC chip 220 and has tamper resistance. The data processing unit 230 reads data from and writes new data to the internal memory 238, and updates the data stored therein. For example, various types of data such as identification information, an electronic value, or application data are stored in the internal memory 238. FIG. 8 shows an example in which the internal memory 238 stores identification information 250 and an electronic value 252.

The detection unit 222 generates a rectangular detection signal, for example, based on the high-frequency signal and delivers the detection signal to the data processing unit 230. Moreover, the data processing unit 230 uses the delivered detection signal as a processing clock for data processing, for example. Here, since the detection signal is based on the high-frequency signal transmitted from the communication apparatus 100, the detection signal is synchronized to the frequency of the high-frequency signal. Thus, since the IC chip 220 includes the detection unit 222, the process performed between the IC chip 220 and the communication apparatus 100 can be performed in synchronization with the communication apparatus 100.

The wave detector 224 rectifies a voltage (hereinafter sometimes referred to as a “received voltage”) corresponding to the received high-frequency signal. Here, although the wave detector 224 is made up of a diode D1 and a capacitor C11, for example, the configuration of the wave detector 224 is not limited to this.

The regulator 226 smoothes the received voltage to obtain a constant voltage and outputs a driving voltage to the data processing unit 230. Here, the regulator 226 uses a DC component of the received voltage, for example, as the driving voltage.

The demodulating unit 228 demodulates a high-frequency signal based on the received voltage and outputs data (for example, a data signal digitized to high level and low level) corresponding to the high-frequency signal. Here, the demodulating unit 228 outputs the AC component of the received voltage as data, for example.

The data processing unit 230 is driven using the driving voltage output from the regulator 226 as a power supply and processes the data demodulated by the demodulating unit 228. Here, although the data processing unit 230 is configured as a MPU, for example, the configuration of the data processing unit 230 is not limited to this.

Moreover, the data processing unit 230 selectively generates a control signal for controlling load modulation associated with the response to the communication apparatus 100 in accordance with the processing results. Moreover, the data processing unit 230 selectively outputs the control signal to the load modulation unit 232.

The load modulation unit 232 includes a load Z and a switch SW1, for example, and performs load modulation by selectively connecting (activating) the load Z in accordance with the control signal delivered from the data processing unit 230. Here, although the load Z is configured as a resistor having a predetermined resistance value, for example, the configuration of the load Z is not limited to this. Moreover, although the switch SW1 is configured as a p-channel MOSFET or an n-channel MOSFET, for example, the configuration of the switch SW1 is not limited to this.

With the configuration shown in FIG. 8, for example, the IC chip 220 processes the received high-frequency signal and transmits a response signal so as to be superimposed on the power line by load modulation. Naturally, the configuration of the IC chip 220 according to the present embodiment is not limited to the configuration shown in FIG. 8.

With the configuration shown in FIG. 8, for example, the power line communication unit 204 is driven by obtaining power from the received high-frequency signal to perform a process indicated by the received high-frequency signal to thereby be able to transmit a response signal corresponding to the process by load modulation.

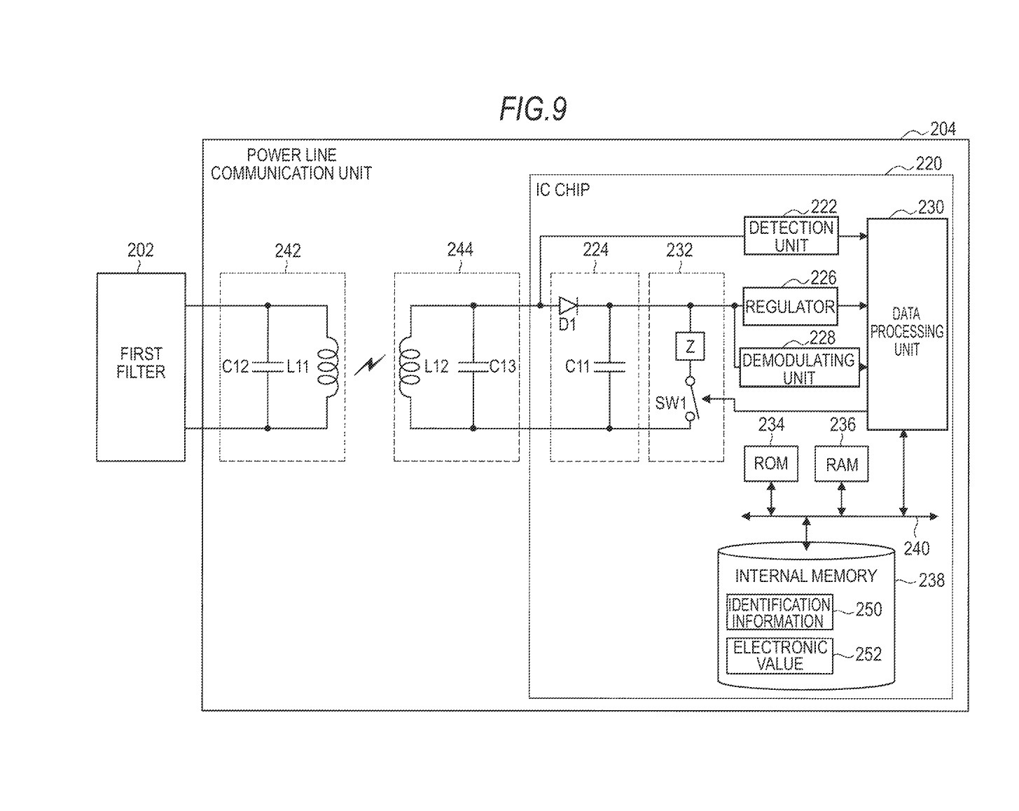

The configuration of the power line communication unit 204 according to the present embodiment is not limited to the configuration shown in FIG. 8. FIG. 9 is a diagram illustrating another example of the power line communication unit 204 included in the electronic apparatus 200 according to the present embodiment. FIG. 9 also shows the first filter 202 similarly to FIG. 8. In the power line communication unit 204 according to the present embodiment, the respective constituent components constituting the IC chip 220 shown in FIG. 9 may not necessarily have the form of an IC chip.

The power line communication unit 204 shown in FIG. 9 includes a first high-frequency transceiving unit 242, a second high-frequency transceiving unit 244, and the IC chip 220.

The first high-frequency transceiving unit 242 includes an inductor L11 having a predetermined inductance and a capacitor C12 having a predetermined capacitance, for example, and constitutes a resonance circuit. Here, the resonance frequency of the first high-frequency transceiving unit 242 may be the frequency of the high-frequency signal, such as 13.56 [MHz], for example. With the above configuration, the first high-frequency transceiving unit 242 transmits the high-frequency signal delivered from the first filter 202 and receives the response signal transmitted from the second high-frequency transceiving unit 244. That is, the first high-frequency transceiving unit 242 performs the function of a first communication antenna in the power line communication unit 204.

The second high-frequency transceiving unit 244 includes an inductor L12 having a predetermined inductance and a capacitor C13 having a predetermined capacitance, for example, and constitutes a resonance circuit. Here, the resonance frequency of the second high-frequency transceiving unit 244 may be the frequency of the high-frequency signal, such as 13.56 [MHz], for example. With the above configuration, the second high-frequency transceiving unit 244 receives the high-frequency signal transmitted from the first high-frequency transceiving unit 242 and transmits the response signal. More specifically, the second high-frequency transceiving unit 244 generates an induced voltage by electromagnetic induction in response to the high-frequency signal and outputs the received voltage obtained by resonating the induced voltage with a predetermined resonance frequency to the IC chip 220. Moreover, the second high-frequency transceiving unit 244 transmits the response signal by the load modulation performed by the load modulation unit 232 included in the IC chip 220. That is, the second high-frequency transceiving unit 244 performs the function of a second communication antenna in the power line communication unit 204.

The IC chip 220 has the same configuration as the IC chip 220 shown in FIG. 8 and performs the same processing as the IC chip 220 shown in FIG. 8 based on the received voltage delivered from the second high-frequency transceiving unit 244.

The power line communication unit 204 having the configuration shown in FIG. 9 is driven by obtaining power from the received high-frequency signal to perform a process indicated by the received high-frequency signal to thereby be able to transmit the response signal corresponding to the process by load modulation similarly to the configuration shown in FIG. 8. Moreover, when the power line communication unit 204 has the configuration shown in FIG. 9, since it is possible to use an IC chip associated with the NFC or RFID technique, mounting is made easier.

The configuration of the electronic apparatus 200 according to the present embodiment will be described with reference again to FIG. 1. The second filter 206 has a function of filtering signals which can be delivered from the side of the communication apparatus 100 via the external power line EPL. More specifically, the second filter 206 has a function of blocking at least the high-frequency signal transmitted by the communication apparatus 100 and the high-frequency signal transmitted by the power line communication unit 204 and not blocking power supplied via the power line. Since the electronic apparatus 200 has the second filter 206, it is possible to block the high-frequency signal associated with communication via the power line and noise components. That is, the second filter 206 performs the function of a so-called power splitter similarly to the third filter 118 included in the communication apparatus 100.

Here, the second filter 206 can have the same configuration as the third filter 118 included in the communication apparatus 100 shown in FIG. 7, for example. Naturally, the configuration of the second filter 206 according to the present embodiment is not limited to the configuration shown in FIG. 7.

With the configuration shown in FIG. 1, for example, the electronic apparatus 200 can perform the wired communication by the power line PL according to the present embodiment with the communication apparatus 100. Naturally, the configuration of the electronic apparatus 200 according to the present embodiment is not limited to the configuration shown in FIG. 1.

[iii] External Apparatus Capable of Performing Wireless Communication Via Antenna Connected to Power Line PL According to Present Embodiment

Next, an example of the configuration of an external apparatus capable of performing wireless communication via an antenna connected to the power line according to the present embodiment will be described. The external apparatus capable of performing wireless communication via an antenna connected to the power line according to the present embodiment includes a communication antenna having the same configuration as the second high-frequency transceiving unit 244 shown in FIG. 9, for example, and an IC chip having the same configuration as the IC chip 220 shown in FIG. 9. In the external apparatus capable of performing wireless communication via an antenna connected to the power line according to the present embodiment, the respective constituent components constituting the IC chip 220 shown in FIG. 9 may not necessarily have the form of an IC chip.

For example, the apparatus having the above configuration can perform NFC communication. Thus, with the above configuration, for example, an external apparatus capable of performing wireless communication via an antenna connected to the power line according to the present embodiment is realized.

The configuration of the external apparatus capable of performing wireless communication via an antenna connected to the power line according to the present embodiment is not limited to the above-described configuration. For example, the external apparatus capable of performing wireless communication via an antenna connected to the power line according to the present embodiment may be an optional apparatus capable of performing NFC communication, such as a mobile phone including an IC card or an IC chip. Thus, the external apparatus capable of performing wireless communication via an antenna connected to the power line according to the present embodiment may further include a device for realizing various functions such as a phone function or an image processing function, for example.

### [II] Communication Apparatus According to Second Embodiment

With the configuration of the communication apparatus 100 according to the first embodiment shown in FIG. 1, for example, it is possible to realize the process associated with the communication method according to the present embodiment. Thus, with the configuration of the communication apparatus 100 according to the first embodiment shown in FIG. 1, for example, the communication with an external apparatus is realized by both the wired communication by the power line PL and the wireless communication via an antenna connected to the power line PL. However, the configuration of the communication apparatus according to the present embodiment capable of realizing the process associated with the communication method according to the present embodiment is not limited to the configuration shown in FIG. 1.

For example, although the communication apparatus 100 including the power line communication unit 108 generating and transmitting the high-frequency signal has been illustrated as the communication apparatus according to the first embodiment, the communication apparatus according to the present embodiment may be configured to receive power and/or a communication signal (e.g., a high-frequency signal) generated by another apparatus (e.g., a separate apparatus) such as the management apparatus via the power line PL and transmit the received high-frequency signal to an external apparatus which is a communication counterpart of the wired communication and the wireless communication according to the present embodiment. In the case of the above configuration, the communication apparatus according to the present embodiment receives a response signal transmitted from the external apparatus which is a communication counterpart of the wired communication and the wireless communication according to the present embodiment and transmits the received response signal to an apparatus having generated the high-frequency signal via the power line PL, for example. That is, the communication apparatus according to the present embodiment can perform the role of a relay apparatus that relays communication between another apparatus such as a management apparatus generating a high-frequency signal and an external apparatus which is a communication counterpart of the wired communication and the wireless communication according to the present embodiment.

Next, an example of the configuration of the communication apparatus according to the second embodiment, capable of performing the role of the relay apparatus will be described.

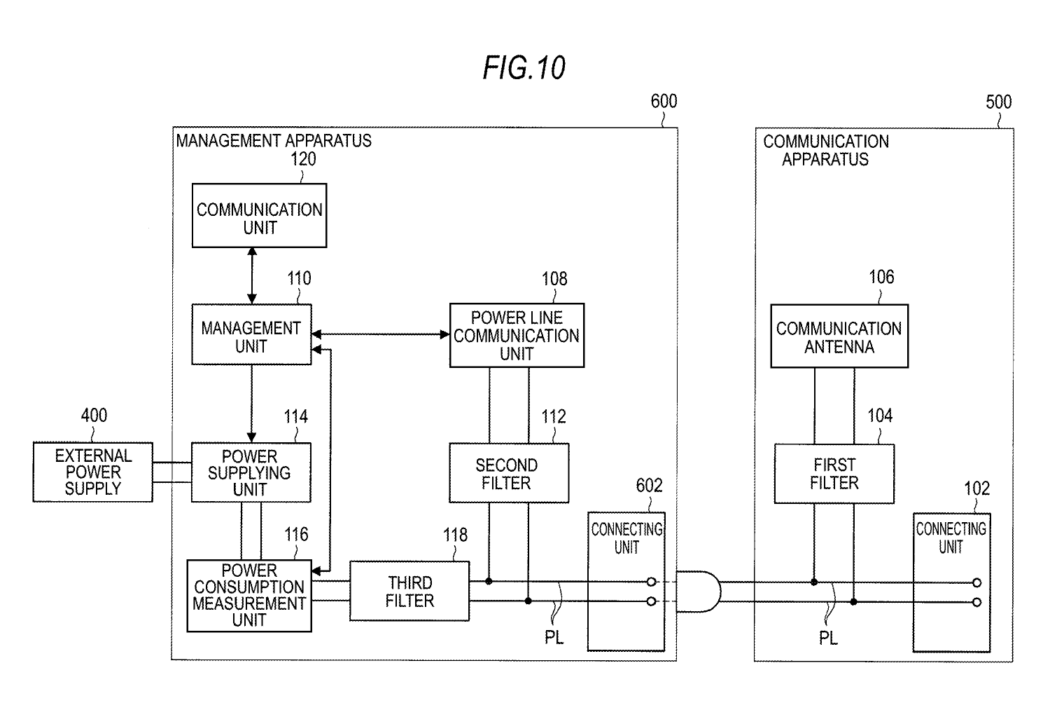

FIG. 10 is a diagram illustrating an example of the configuration of a communication apparatus 500 according to the second embodiment. FIG. 10 also shows an external power supply 400 and a management apparatus 600 connected to the communication apparatus 500 by the power line PL. Hereinafter, an example of the configuration of the management apparatus 600 according to the present embodiment as well as an example of the configuration of the communication apparatus 500 will be described.

[iv] Communication Apparatus 500 According to Second Embodiment

The communication apparatus 500 includes a connecting unit 102, a first filter 104 (first communication filter), and a communication antenna 106. Here, the connecting unit 102, the first filter 104, and the communication antenna 106 have the same configurations as the connecting unit 102, the first filter 104, and the communication antenna 106 included in the communication apparatus 100 according to the first embodiment shown in FIG. 1, respectively, for example.

With the configuration shown in FIG. 10, the communication apparatus 500 according to the second embodiment transmits a high-frequency signal via the power line PL through which power and a high-frequency signal are transmitted and via the communication antenna 106 electrically connected to the power line PL. Moreover, the communication apparatus 500 receives signals transmitted by load modulation from an external apparatus connected through wires by the power line PL or an external apparatus performing non-contact communication via the communication antenna 106. That is, with the configuration shown in FIG. 10, for example, the communication apparatus 500 can perform processing (for example, the processing (transmitting process) (1) and the processing (receiving process) (2)) associated with the communication method according to the present embodiment.

Therefore, with the configuration shown in FIG. 10, for example, the communication apparatus 500 according to the second embodiment can perform communication directly with the external apparatus by both the wired communication by the power line PL and the wireless communication via the antenna connected to the power line PL.

Moreover, the communication apparatus 500 includes a plug at the distal end of the power line PL, for example. When the plug is connected to the terminal (for example, an outlet) of a connecting unit (described later) of the management apparatus 600, the communication apparatus 500 and the management apparatus 600 are connected by the power line PL. The communication apparatus 500 and the management apparatus 600 may be connected via an extension cord, for example.

### [v] Management Apparatus 600

The management apparatus 600 is connected to the communication apparatus 500 by the power line PL and performs communication indirectly with an external apparatus which is a communication counterpart of the wired communication and the wireless communication according to the present embodiment via the communication apparatus 500.

The management apparatus 600 includes a connecting unit 602, a power line communication unit 108, a management unit 110, a second filter 112 (second communication filter), a power supplying unit 114, a power consumption measurement unit 116, a third filter 118, and a communication unit 120, for example. Here, the connecting unit 602 has the same configuration as the connecting unit 102 included in the communication apparatus 100 according to the first embodiment shown in FIG. 1, for example. Moreover, the power line communication unit 108, the management unit 110, the second filter 112, the power supplying unit 114, the power consumption measurement unit 116, the third filter 118, and the communication unit 120 have the same configurations as the power line communication unit 108, the management unit 110, the second filter 112, the power supplying unit 114, the power consumption measurement unit 116, the third filter 118, and the communication unit 120 included in the communication apparatus 100 according to the first embodiment shown in FIG. 1, respectively, for example.

Since the management apparatus 600 includes the power line communication unit 108 having the same configuration and function as the power line communication unit 108 included in the communication apparatus 100 according to the first embodiment shown in FIG. 1, the management apparatus 600 can perform communication indirectly with an external apparatus which is a communication counterpart of the wired communication and the wireless communication according to the present embodiment, such as the electronic apparatus 200, via the power line PL (strictly speaking, via the communication apparatus 500).

The configuration of the management apparatus 600 according to the present embodiment is not limited to the configuration shown in FIG. 10. For example, the management apparatus 600 according to the present embodiment may include a control unit (not shown) that controls respective units of the management apparatus 600. Moreover, the management apparatus 600 according to the present embodiment may not include the power supplying unit 114, the power consumption measurement unit 116, and the communication unit 120 shown in FIG. 10.

For example, with the configuration shown in FIG. 10, the communication apparatus 500 can perform communication directly with the external apparatus which is a communication counterpart of the wired communication and the wireless communication according to the present embodiment, and the management apparatus 600 can perform communication indirectly with the external apparatus which is a communication counterpart of the wired communication and the wireless communication according to the present embodiment. Therefore, with the communication apparatus 500 and the management apparatus 600 shown in FIG. 10, for example, a communication system capable of performing communication with an external apparatus by both the wired communication by power line and the wireless communication via an antenna connected to the power line is realized.

As above, the communication apparatus according to the present embodiment performs the processing (transmitting process) (1) and the processing (receiving process) (2), for example, as the process associated with the communication method according to the present embodiment. Here, the communication apparatus according to the present embodiment applies a wireless communication technique such as a NFC communication technique or an RFID technique to the wired communication by power line. Therefore, it is possible to realize wired communication capable of reducing cost, relieving the limitation of the size of a communication device, and reducing power consumption as compared to wired communication by power line using the existing PLC technique, for example. Moreover, the communication apparatus according to the present embodiment performs non-contact communication with an external apparatus via a communication antenna electrically connected to the power line. Therefore, the communication apparatus according to the present embodiment can further decrease the cost of devices for performing communication with an external apparatus as compared to a case where the communication apparatus further includes a communication device associated with the existing wireless communication technique. Moreover, the communication apparatus according to the present embodiment can perform management of communication more easily than a case where the communication apparatus further includes a communication device associated with the existing wireless communication technique.

Therefore, the communication apparatus according to the present embodiment can perform communication with an external apparatus by both the wired communication by power line and the wireless communication via an antenna connected to a power line.

Moreover, the communication apparatus according to the present embodiment (or the management apparatus according to the present embodiment performing communication indirectly with the external apparatus via the communication apparatus according to the present embodiment) can specify the communication counterpart external apparatus based on the identification information acquired from the external apparatus by the wired communication by power line according to the present embodiment or the wireless communication via an antenna connected to the power line according to the present embodiment and authenticate the external apparatus. Therefore, the communication apparatus according to the present embodiment (or the management apparatus according to the present embodiment performing communication indirectly with the external apparatus via the communication apparatus according to the present embodiment) can perform a process in accordance with the authentication results. Here, examples of the process performed in accordance with the authentication results include a process of selectively supplying power to the external apparatus connected to the power line via the connecting unit when authentication was successful, for example, and a billing process (an example of a process using the second high-frequency signal) in accordance with the supplied power.

Here, the communication apparatus according to the present embodiment can perform communication with the external apparatus by both the wired communication by power line and the wireless communication via an antenna connected to the power line. That is, the communication apparatus according to the present embodiment (or the management apparatus according to the present embodiment performing communication indirectly with the external apparatus via the communication apparatus according to the present embodiment) includes a plurality of communication units specifying and authenticating the external apparatus. Therefore, even if the external apparatus which is unable to perform the wired communication by power line according to the present embodiment is connected through wires by the power line, the communication apparatus according to the present embodiment (or the management apparatus according to the present embodiment performing communication indirectly with the external apparatus via the communication apparatus according to the present embodiment) can authenticate the external apparatus based on the identification information acquired by the wireless communication via an antenna connected to the power line, for example, and perform a process in accordance with the authentication results.

Therefore, the communication apparatus according to the present embodiment (or the communication system according to the present embodiment including the communication apparatus according to the present embodiment and the management apparatus according to the present embodiment) can improve the convenience of users.

Furthermore, since the communication apparatus according to the present embodiment performs communication with the external apparatus by both the wired communication by power line and the wireless communication via an antenna connected to the power line, the communication apparatus according to the present embodiment (or the management apparatus according to the present embodiment performing communication indirectly with the external apparatus via the communication apparatus according to the present embodiment) does not have to include a plurality of power line communication units that generates and transmits the high-frequency signal for performing the wired communication and the wireless communication according to the present embodiment with the external apparatus. Therefore, the communication apparatus according to the present embodiment (or the management apparatus according to the present embodiment performing communication indirectly with the external apparatus via the communication apparatus according to the present embodiment) can further simplify its configuration.

Although the communication apparatus 100 according to the first embodiment and the communication apparatus 500 according to the second embodiment have been described as an example of the present embodiment, the present embodiment is not limited to the above examples. The present embodiment can be applied to various apparatuses such as, for example, a computer (for example, a personal computer (PC) or a server), a power tap, a power feeding apparatus capable of supplying power to an electric vehicle (EV) or other power-driven apparatuses, a display apparatus, or the like. Moreover, the present embodiment can be applied to vehicles that perform the role of a power feeding apparatus, for example.

Moreover, although the electronic apparatus 200 has been described as an example of the present embodiment, the present embodiment is not limited to the above example. The present embodiment can be applied to various power-driven apparatuses such as, for example, a computer (for example, a PC), a communication apparatus (for example, a mobile phone or a smart phone), a video/music player (or a video/music recorder and player), a game machine, a display apparatus, a television receiver, an illumination apparatus, a toaster, or a vehicle (for example, an electric vehicle (EV)).

Moreover, although the server 300 has been described as an example of the present embodiment, the present embodiment is not limited to the above example. The present embodiment can be applied to such as, for example, a computer (for example, a PC or a server), or a group of computers constituting a system (for example, a cloud computing system) designed for connecting to a network.

Moreover, although the management apparatus 600 has been described as an example of the present embodiment, the present embodiment is not limited to the example. The present embodiment can be applied to various apparatuses such as, for example, a computer (for example, a PC or a server) or a power feeding apparatus capable of supplying power to power-driven apparatuses.

While preferred embodiments of the present disclosure have been described in detail with reference to the accompanying drawings, the present disclosure is not limited to the embodiments. Those skilled in the art will readily appreciate that various modifications and changes may be made in the embodiment without departing from the technical spirit as described in the appended claims. Accordingly, all such modifications and changes are intended to be included within the scope of the present disclosure as defined in the appended claims.

Further, the following configurations are also included in the technical scope of the present disclosure.

1. A communication apparatus comprising: at least one connection terminal configured to connect with at least one external power line coupled to an external apparatus; at least one internal power line configured to carry power and a communication signal to the at least one connection terminal; and a wireless communication circuit connected to the at least one internal power line, the wireless communication circuit having an input configured to receive the power and the communication signal from the at least one internal power line, wherein the wireless communication circuit is further configured to separate the communication signal from the power, and to wirelessly transmit the communication signal to the external apparatus.

2. The communication apparatus of configuration 1, wherein the wireless communication circuit comprises: a filter, connected to the at least one internal power line, configured to block a frequency of the power and to pass a frequency of the communication signal; and a communication antenna, connected to the filter, configured to wirelessly transmit the communication signal to the external apparatus.

3. The communication apparatus of configuration 1, wherein the wireless communication circuit comprises a series resonance circuit comprising a capacitor configured to block a frequency of the power.

4. The communication apparatus of configuration 1, wherein a frequency of the communication signal is higher than a frequency of the power.

5. The communication apparatus of configuration 1, further comprising an internal power supply configured to generate the power carried by the at least one internal power line.

6. The communication apparatus of configuration 5, further comprising at least one processor programmed to generate a control signal to cause the at least one internal power line to be selectively connected to the internal power supply or to an external power supply.

7. The communication apparatus of configuration 1, wherein the at least one internal power line is configured to receive the power from a management apparatus separate from the communication apparatus.

8. The communication apparatus of configuration 1, further comprising at least one processor programmed to receive identification information from the external apparatus, and to authenticate the external apparatus using the identification information.

9. A communication apparatus comprising: means for connecting with at least one external power line coupled to an external apparatus; means for carrying power and a communication signal to the means for connecting; and means, connected to the means for carrying the power and the communication signal, for wirelessly transmitting the communication signal to the external apparatus.

10. The communication apparatus of configuration 9, wherein the means for wirelessly transmitting the communication signal comprises means for blocking a frequency of the power.

11. The communication apparatus of configuration 9, wherein the means for wirelessly transmitting the communication signal comprises means for passing a frequency of the communication signal.

12. The communication apparatus of configuration 9, wherein a frequency of the communication signal is higher than a frequency of the power.

13. The communication apparatus of configuration 9, further comprising means for internally generating the power carried by the means for carrying power.

14. The communication apparatus of configuration 13, further comprising means for selectively connecting the means for carrying the power and the communication signal to the means for internally generating the power or to an external power supply.

15. The communication apparatus of configuration 9, wherein the means for carrying the power and the communication signal is configured to receive the power from a management apparatus separate from the communication apparatus.

16. The communication apparatus of configuration 9, further comprising means for receiving identification information from the external apparatus, and for authenticating the external apparatus using the identification information.

17. A system comprising an electronic apparatus configured to receive power and a communication signal via an external power line; and a communication apparatus comprising: at least one connection terminal configured to connect with at least one external power line coupled to the electronic apparatus; at least one internal power line configured to carry power and a communication signal to the at least one connection terminal; and a wireless communication circuit connected to the at least one internal power line, the wireless communication circuit having an input configured to receive the power and the communication signal from the at least one internal power line, wherein the wireless communication circuit is further configured to separate the communication signal from the power, and to wirelessly transmit the communication signal to the electronic apparatus.

18. The system of configuration 17, wherein the wireless communication circuit comprises: a filter, connected to the at least one internal power line, configured to block a frequency of the power and to pass a frequency of the communication signal; and a communication antenna, connected to the filter, configured to wirelessly transmit the communication signal to the electronic apparatus.

19. The system of configuration 17, wherein the wireless communication circuit comprises a series resonance circuit comprising a capacitor configured to block a frequency of the power.

20. The system of configuration 17, wherein a frequency of the communication signal is higher than a frequency of the power.

21. The system of configuration 17, wherein the communication apparatus further comprises an internal power supply configured to generate the power carried by the at least one internal power line.

22. The system of configuration 21, wherein the communication apparatus further comprises at least one processor programmed to generate a control signal to cause the at least one internal power line to be selectively connected to the internal power supply or to an external power supply.

23. The system of configuration 17, wherein the at least one internal power line is configured to receive the power from a management apparatus separate from the communication apparatus.

24. The system of configuration 17, wherein the communication apparatus further comprises at least one processor programmed to receive identification information from the electronic apparatus, and to authenticate the electronic apparatus using the identification information.

25. A system comprising an electronic apparatus configured to receive power and a communication signal via an external power line; and a communication apparatus comprising: means for connecting with at least one external power line coupled to the electronic apparatus; means for carrying power and a communication signal to the means for connecting; and means, connected to the means for carrying the power and the communication signal, for wirelessly transmitting the communication signal to the electronic apparatus.

26. The system of configuration 25, wherein the means for wirelessly transmitting the communication signal comprises means for blocking a frequency of the power.

27. The system of configuration 25, wherein the means for wirelessly transmitting the communication signal comprises means for passing a frequency of the communication signal.

28. The system of configuration 25, wherein a frequency of the communication signal is higher than a frequency of the power.

29. The system of configuration 25, wherein the communication apparatus further comprises means for internally generating the power carried by the means for carrying power.

30. The system of configuration 29, wherein the communication apparatus further comprises means for selectively connecting the means for carrying the power and the communication signal to the means for internally generating the power or to an external power supply.

31. The system of configuration 25, wherein the means for carrying the power and the communication signal is configured to receive the power from a management apparatus separate from the communication apparatus.

32. The system of configuration 25, wherein the communication apparatus further comprises means for receiving identification information from the electronic apparatus, and for authenticating the electronic apparatus using the identification information.

33. A method comprising: transmitting power and a communication signal via a power line; separating the communication signal from the power via a circuit connected to the power line; and wirelessly transmitting the separated communication signal via a communication antenna.

34. The method of configuration 33, wherein separating the communication signal from the power comprises blocking a frequency of the power and passing a frequency of the communication signal.

35. The method of configuration 33, wherein a frequency of the communication signal is higher than a frequency of the power.

36. The method of configuration 33, further comprising receiving a signal via load modulation on the power line.

The present disclosure contains subject matter related to that disclosed in Japanese Priority Patent Application JP 2011-196302 filed in the Japan Patent Office on Sep. 8, 2011, the entire contents of which are hereby incorporated by reference.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of embodiments of the present invention comprises at least one computer-readable storage medium (i.e., a tangible, non-transitory computer-readable medium, such as a computer memory, a floppy disk, a compact disk, a magnetic tape, or other tangible, non-transitory computer-readable medium) encoded with a computer program (i.e., a plurality of instructions), which, when executed on one or more processors, performs above-discussed functions of embodiments of the present invention. The computer-readable storage medium can be transportable such that the program stored thereon can be loaded onto any computer resource to implement aspects of the present invention discussed herein. In addition, it should be appreciated that the reference to a computer program which, when executed, performs any of the above-discussed functions, is not limited to an application program running on a host computer. Rather, the term “computer program” is used herein in a generic sense to reference any type of computer code (e.g., software or microcode) that can be employed to program one or more processors to implement above-discussed aspects of the present invention.

The phraseology and terminology used herein is for the purpose of description and should not be regarded as limiting. The use of “including,” “comprising,” “having,” “containing”, “involving”, and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements from each other.

It should be understood by those skilled in the art that various modifications, combinations, sub-combinations and alterations may occur depending on design requirements and other factors insofar as they are within the scope of the appended claims or the equivalents thereof.

What is claimed is:

1. A communication apparatus comprising:
at least one connection terminal configured to connect with at least one external power line coupled to an external apparatus;
at least one internal power line configured to carry power and a communication signal to the at least one connection terminal; and
a wireless communication circuit connected to the at least one internal power line, the wireless communication circuit having an input configured to receive the power and the communication signal from the at least one internal power line, wherein the wireless communication circuit is further configured to separate the communication signal from the power, and to wirelessly transmit the communication signal to the external apparatus.

2. The communication apparatus of claim 1, wherein the wireless communication circuit comprises:
a filter, connected to the at least one internal power line, configured to block a frequency of the power and to pass a frequency of the communication signal; and
a communication antenna, connected to the filter, configured to wirelessly transmit the communication signal to the external apparatus.

3. The communication apparatus of claim 1, wherein the wireless communication circuit comprises a series resonance circuit comprising a capacitor configured to block a frequency of the power.

4. The communication apparatus of claim 1, wherein a frequency of the communication signal is higher than a frequency of the power.

5. The communication apparatus of claim 1, further comprising an internal power supply configured to generate the power carried by the at least one internal power line.

6. The communication apparatus of claim 5, further comprising at least one processor programmed to generate a control signal to cause the at least one internal power line to be selectively connected to the internal power supply or to an external power supply.

7. The communication apparatus of claim 1, wherein the at least one internal power line is configured to receive the power from a management apparatus separate from the communication apparatus.

8. The communication apparatus of claim 1, further comprising at least one processor programmed to receive identification information from the external apparatus, and to authenticate the external apparatus using the identification information.

9. A communication apparatus comprising:
means for connecting with at least one external power line coupled to an external apparatus;
means for carrying power and a communication signal to the means for connecting; and
means, connected to the means for carrying the power and the communication signal, for wirelessly transmitting the communication signal to the external apparatus.

10. The communication apparatus of claim 9, wherein the means for wirelessly transmitting the communication signal comprises means for blocking a frequency of the power.

11. The communication apparatus of claim 9, wherein the means for wirelessly transmitting the communication signal comprises means for passing a frequency of the communication signal.

12. The communication apparatus of claim 9, wherein a frequency of the communication signal is higher than a frequency of the power.

13. The communication apparatus of claim 9, further comprising means for internally generating the power carried by the means for carrying power.

14. The communication apparatus of claim 13, further comprising means for selectively connecting the means for carrying the power and the communication signal to the means for internally generating the power or to an external power supply.

15. The communication apparatus of claim 9, wherein the means for carrying the power and the communication signal is configured to receive the power from a management apparatus separate from the communication apparatus.

16. The communication apparatus of claim 9, further comprising means for receiving identification information from the external apparatus, and for authenticating the external apparatus using the identification information.

17. A system comprising:
an electronic apparatus configured to receive power and a communication signal via an external power line; and
a communication apparatus comprising:
at least one connection terminal configured to connect with at least one external power line coupled to the electronic apparatus;
at least one internal power line configured to carry power and a communication signal to the at least one connection terminal; and
a wireless communication circuit connected to the at least one internal power line, the wireless communication circuit having an input configured to receive the power and the communication signal from the at least one internal power line, wherein the wireless communication circuit is further configured to separate the communication signal from the power, and to wirelessly transmit the communication signal to the electronic apparatus.

18. A system comprising:
an electronic apparatus configured to receive power and a communication signal via an external power line; and
a communication apparatus comprising:
means for connecting with at least one external power line coupled to the electronic apparatus;
means for carrying power and a communication signal to the means for connecting; and
means, connected to the means for carrying the power and the communication signal, for wirelessly transmitting the communication signal to the electronic apparatus.

19. A method comprising:
transmitting power and a communication signal via a power line;
separating the communication signal from the power via a circuit connected to the power line; and
wirelessly transmitting the separated communication signal via a communication antenna.
